(19) United States
(12) Patent Application Publication
(10) Pub. No.: US 2018/0129274 A1
(43) Pub. Date: May 10, 2018

(54) INFORMATION PROCESSING METHOD AND APPARATUS, AND PROGRAM FOR EXECUTING THE INFORMATION PROCESSING METHOD ON COMPUTER

(71) Applicant: COLOPL, Inc., Tokyo (JP)

(72) Inventor: Yuki KONO, Tokyo (JP)

(21) Appl. No.: 15/786,552

(22) Filed: Oct. 17, 2017

(30) Foreign Application Priority Data
Oct. 18, 2016 (JP) 2016-204341
Dec. 12, 2016 (JP) 2016-240343

(51) Int. Cl. G06F 3/01; G06F 3/042; A63F 13/525; A63F 13/25; A63F 13/212; A63F 13/211

(52) U.S. Cl. CPC G06F 3/011; G06F 3/017; G06F 3/0425; A63F 2300/8082; A63F 13/25; A63F 13/212; A63F 13/211; A63F 13/525

(57) ABSTRACT

A method includes defining a virtual space. The virtual space includes a virtual camera configured to define a visual field; a target object; and an operation object for operating the target object. The method includes detecting a movement of a part of a body of a user wearing a HMD. The method includes moving the operation object in accordance with the detected movement. The method includes specifying an operation performed on the target object by the operation object. The method includes detecting that the operation has been executed based on the detected movement of the part of the body. The method includes setting one of the virtual camera or the target object as an execution subject based on first attribute information representing an attribute associated with the target object. The method includes causing the execution subject to execute an action corresponding to a movement of the operation object.

### RELATED APPLICATIONS

The present application claims priority to Japanese applications Nos. 2016-204341, filed Oct. 18, 2016 and 2016-240343, filed Dec. 12, 2016. The disclosures of all above-listed Japanese applications are hereby incorporated by reference herein in their entirety.

### TECHNICAL FIELD

This disclosure relates to an information processing method and an apparatus, and a system for executing the information processing method.

### BACKGROUND

In Non-Patent Document 1, there is described a technology for displaying, in a virtual space, a hand object synchronized with a movement of a hand of a user in a real space and enabling the hand object to operate a virtual object in the virtual space.

### RELATED ART

### Non-Patent Documents

[Non-Patent Document 1] “Toybox Demo for Oculus Touch”, [online], Oct. 13, 2015, Oculus, [retrieved on Oct. 7, 2016], Internet <https://www.youtube.com/watch?v=dbYP4bhKr2M>

### SUMMARY

In Non-patent Literature 1, when an action executed in accordance with the operation of the hand object for the virtual object is uniformly determined irrespective of properties of the virtual object, an entertainment value exhibited in the virtual space may be impaired in some instances.

According to at least one embodiment of this disclosure, there is provided an information processing method to be executed by a system in order to provide a user with a virtual experience in a virtual space. The information processing method includes generating virtual space data for defining the virtual space. The virtual space includes a virtual camera configured to define a visual field of the user in the virtual space; a target object arranged in the virtual space; and an operation object for operating the target object. The method further includes detecting a movement of a part of a body of the user to move the operation object in accordance with the detected movement of the part of the body. The method further includes detecting an operation determined in advance and performed on the target object by the operation object. The method further includes acquiring, in response to detection of the operation determined in advance, first attribute information representing an attribute associated with the target object to determine an action to be executed and determine at least one of the virtual camera or the target object as an execution subject of the action based on the first attribute information. The method further includes causing the at least one of the virtual camera or the target object determined as the execution subject to execute the action.

### BRIEF DESCRIPTION OF THE DRAWINGS

FIG. 1 A diagram of a configuration of an HMD system 100 of at least one embodiment of this disclosure.

FIG. 2 A block diagram of a hardware configuration of a computer 200 of at least one embodiment of this disclosure.

FIG. 3 A diagram of a uvw visual-field coordinate system to be set for an HMD device 110 of at least one embodiment of this disclosure.

FIG. 4 A diagram of a virtual space 2 of at least one embodiment of this disclosure.

FIG. 5 A top view diagram of a head of a user 190 wearing the HMD device 110 of at least one embodiment of this disclosure.

FIG. 6 A diagram of a YZ cross section obtained by viewing a field-of-view region 23 from an X direction in the virtual space 2 of at least one embodiment of this disclosure.

FIG. 7 A diagram of an XZ cross section obtained by viewing the field-of-view region 23 from a Y direction in the virtual space 2 of at least one embodiment of this disclosure.

FIG. 8A A diagram of a schematic configuration of a controller 160 of at least one embodiment of this disclosure.

FIG. 8B A diagram of a coordinate system for a user's hand of at least one embodiment.

FIG. 9 A block diagram of hardware of a module configuration of at least one embodiment of this disclosure.

FIG. 10A A diagram of the user 190 wearing the HMD device 110 and the controller 160 of at least one embodiment.

FIG. 10B A diagram of the virtual space 2 that includes a virtual camera 1, a hand object 400, and a target object 500 of at least one embodiment.

FIG. 11 A flowchart of a processing method executed by the HMD system 100 of at least one embodiment.

FIG. 12 A flowchart of processing of Step S8 of FIG. 11 of at least one embodiment.

FIG. 13 A flowchart of processing of Step S9 of FIG. 11 of at least one embodiment.

FIG. 14A A diagram of a field of view image of a first action of at least one embodiment.

FIG. 14B A diagram of a virtual space of a first action of at least one embodiment.

FIG. 15A A diagram of a field of view image of a first action of at least one embodiment.

FIG. 15B A diagram of a virtual space of a first action of at least one embodiment.

FIG. 16A A diagram of a field of view image of a second action of at least one embodiment.

FIG. 16B A diagram of a virtual space of a second action of at least one embodiment.

FIG. 17A A diagram of a field of view image of a second action of at least one embodiment.

FIG. 17B A diagram of a virtual space of a second action of at least one embodiment.

FIG. 18 A flowchart of the processing of Step S8 of FIG. 11 of at least one embodiment.

FIG. 19 A flowchart of the processing of Step S9 of FIG. 11 of at least one embodiment.

FIG. 20A A diagram of a field of view image of a third action of at least one embodiment.

FIG. 20B A diagram of a virtual space of a third action of at least one embodiment.

FIG. 21A A diagram of a field of view image of a third action of at least one embodiment.

FIG. 21B A diagram of a virtual space of a third action of at least one embodiment.

FIG. 22 A flowchart of processing executed by the HMD system 100 of at least one embodiment.

FIG. 23 A flowchart of processing of Step S9-1 of FIG. 22 of at least one embodiment.

FIG. 24A Diagrams of visual processing for a field-of-view image of at least one embodiment.

FIG. 24B Diagrams of visual processing for a field-of-view image of at least one embodiment.

FIG. 24C Diagrams of visual processing for a field-of-view image of at least one embodiment.

FIG. 25 Diagram of processing performed when a glove 600 being an equipment object is worn on the hand object 400 of at least one embodiment.

### DETAILED DESCRIPTION

Now, with reference to the drawings, embodiments of this disclosure are described. In the following description, like components are denoted by like reference symbols. The same applies to the names and functions of those components. Therefore, detailed description of those components is not repeated.

[Configuration of HMD System]

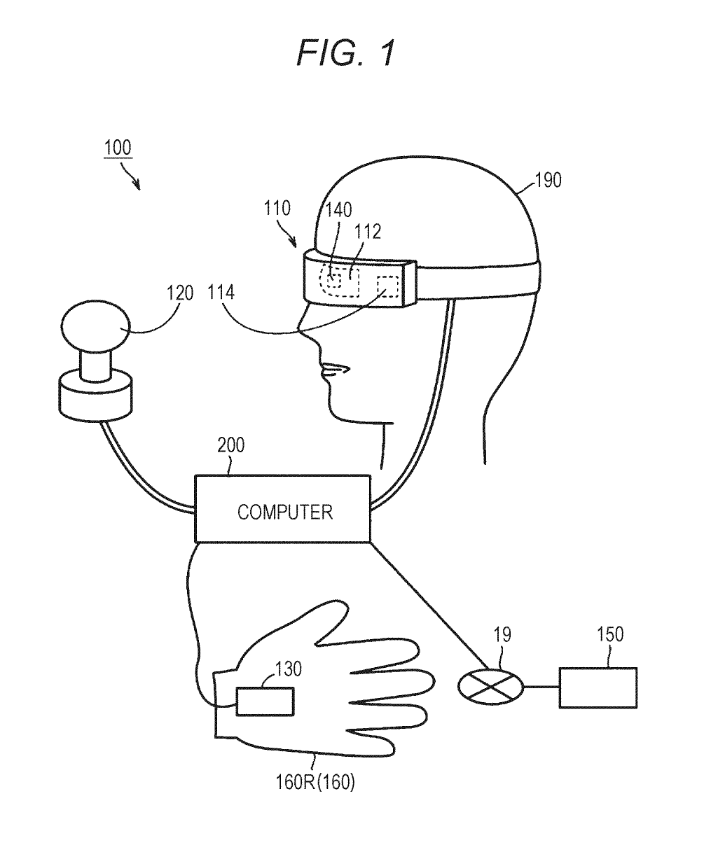

With reference to FIG. 1, a configuration of a headmount display (HMD) system 100 is described. FIG. 1 is a diagram of an overview of the configuration of the HMD system 100 of at least one embodiment of this disclosure. In at least one aspect, the HMD system 100 is a system for household/personal use or a system for business/professional use.

The HMD system 100 includes an HMD device 110, an HMD sensor 120, a controller 160, and a computer 200. The HMD device 110 includes a monitor 112 and an eye gaze sensor 140. The controller 160 may include a motion sensor 130.

In at least one aspect, the computer 200 can be connected to a network 19, for example, the Internet, and can communicate to/from a server 150 or other computers connected to the network 19. In at least one aspect, the HMD device 110 may include a sensor 114 instead of the HMD sensor 120.

The HMD device 110 may be worn on a head of a user to provide a virtual space to the user during operation. More specifically, the HMD device 110 displays each of a right-eye image and a left-eye image on the monitor 112. When each eye of the user is able to visually recognizes each image, the user may recognize the image as a three-dimensional image based on the parallax of both the eyes.

The monitor 112 includes, for example, a non-transmissive display device. In at least one aspect, the monitor 112 is arranged on a main body of the HMD device 110 so as to be positioned in front of both the eyes of the user. Therefore, when the user visually recognizes the three-dimensional image displayed on the monitor 112, the user can be immersed in the virtual space. According to at least one embodiment of this disclosure, the virtual space includes, for example, a background, objects that can be operated by the user, and menu images that can be selected by the user. According to at least one embodiment of this disclosure, the monitor 112 may be achieved as a liquid crystal monitor or an organic electroluminescence (EL) monitor included in a so-called smart phone or other information display terminal.

In at least one aspect, the monitor 112 may include a sub-monitor for displaying a right-eye image and a sub-monitor for displaying a left-eye image. In at least one aspect, the monitor 112 may be configured to integrally display the right-eye image and the left-eye image. In this case, the monitor 112 includes a high-speed shutter. The high-speed shutter alternately displays the right-eye image and the left-eye image so that only one of the eyes can recognize the image.

In at least one aspect, the HMD sensor 120 includes a plurality of light sources. Each light source is achieved by, for example, a light emitting diode (LED) configured to emit an infrared ray. The HMD sensor 120 has a position tracking function for detecting the movement of the HMD device 110. The HMD sensor 120 uses this function to detect the position and the inclination of the HMD device 110 in a real space.

In at least one aspect, the HMD sensor 120 may be achieved by a camera. The HMD sensor 120 may use image information of the HMD device 110 output from the camera to execute image analysis processing, to thereby enable detection of the position and the inclination of the HMD device 110.

In at least one aspect, the HMD device 110 may include the sensor 114 instead of the HMD sensor 120 as a position detector. The HMD device 110 may use the sensor 114 to detect the position and the inclination of the HMD device 110. For example, when the sensor 114 is an angular velocity sensor, a geomagnetic sensor, an acceleration sensor, or a gyrosensor, the HMD device 110 may use any of those sensors instead of the HMD sensor 120 to detect the position and the inclination of the HMD device 110. As an example, when the sensor 114 is an angular velocity sensor, the angular velocity sensor detects over time the angular velocity about each of three axes of the HMD device 110 in the real space. The HMD device 110 calculates a temporal change of the angle about each of the three axes of the HMD device 110 based on each angular velocity, and further calculates an inclination of the HMD device 110 based on the temporal change of the angles. The HMD device 110 may include a transmissive display device. In this case, the transmissive display device may be configured as a display device that is temporarily non-transmissive by adjusting the transmittance of the display device. The field-of-view image may include a section for presenting a real space on a part of the image forming the virtual space. For example, an image photographed by a camera mounted to the HMD device 110 may be superimposed and displayed on apart of the field-of-view image, or the real space may be visually recognized from a part of the field-of-view image by increasing the transmittance of a part of the transmissive display device.

The eye gaze sensor 140 is configured to detect a direction (line-of-sight direction) in which the lines of sight of the right eye and the left eye of a user 190 are directed. The direction is detected by, for example, a known eye tracking function. The eye gaze sensor 140 is achieved by a sensor having the eye tracking function. In at least one aspect, the eye gaze sensor 140 includes a right-eye sensor and a left-eye sensor. The eye gaze sensor 140 may be, for example, a sensor configured to irradiate the right eye and the left eye of the user 190 with infrared light, and to receive reflection light from the cornea and the iris with respect to the irradiation light, to thereby detect a rotational angle of each eyeball. The eye gaze sensor 140 can detect the line-of-sight direction of the user 190 based on each detected rotational angle.

The server 150 may transmit a program to the computer 200. In at least one aspect, the server 150 may communicate to/from another computer 200 for providing virtual reality to an HMD device used by another user. For example, when a plurality of users play a participatory game in an amusement facility, each computer 200 communicates to/from another computer 200 with a signal based on the motion of each user, to thereby enable the plurality of users to enjoy a common game in the same virtual space.

The controller 160 receives input of a command from the user 190 to the computer 200. In at least one aspect, the controller 160 can be held by the user 190. In at least one aspect, the controller 160 can be mounted to the body or a part of the clothes of the user 190. In at least one aspect, the controller 160 may be configured to output at least any one of a vibration, a sound, or light based on the signal transmitted from the computer 200. In at least one aspect, the controller 160 receives an operation given by from the user 190 to control, for example, the position and the movement of an object arranged in the space for providing virtual reality.

In at least one aspect, the motion sensor 130 is mounted on the hand of the user to detect the movement of the hand of the user. For example, the motion sensor 130 detects a rotational speed and the number of rotations of the hand. The detected signal is transmitted to the computer 200. The motion sensor 130 is provided to, for example, the glove-type controller 160. According to at least one embodiment of this disclosure, for the safety in the real space, the controller 160, also labeled as 160R, is mounted on an object like a glove-type object that does not easily fly away by being worn on a hand of the user 190. In at least one aspect, a sensor that is not mounted on the user 190 may detect the movement of the hand of the user 190. For example, a signal of a camera that photographs the user 190 may be input to the computer 200 as a signal representing the motion of the user 190. The motion sensor 130 and the computer 200 are connected to each other through wired or wireless communication. In the case of wireless communication, the communication mode is not particularly limited, and for example, Bluetooth® or other known communication methods may be used.

[Hardware Configuration]

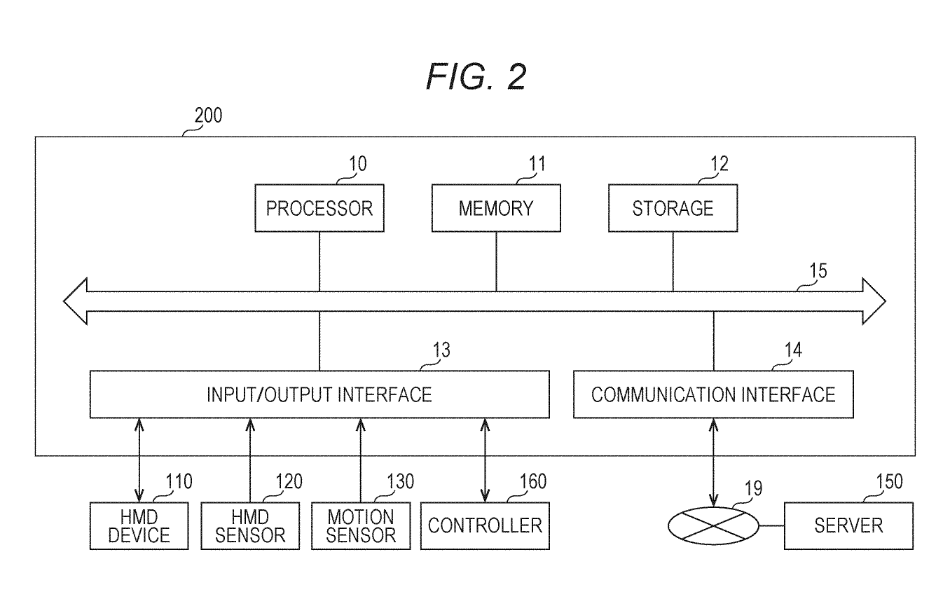

With reference to FIG. 2, the computer 200 of at least one embodiment is described. FIG. 2 is a block diagram of a hardware configuration of the computer 200 of at least one embodiment. The computer 200 includes a processor 10, a memory 11, a storage 12, an input/output interface 13, and a communication interface 14. Each component is connected to a bus 15.

The processor 10 is configured to execute a series of commands included in a program stored in the memory 11 or the storage 12 based on a signal transmitted to the computer 200 or on satisfaction of a condition determined in advance. In at least one aspect, the processor 10 is achieved as a central processing unit (CPU), a micro-processor unit (MPU), a field-programmable gate array (FPGA), or other devices.

The memory 11 stores programs and data. The programs are loaded from, for example, the storage 12. The data stored in the new memory 11 includes data input to the computer 200 and data generated by the processor 10. In at least one aspect, the memory 11 is achieved as a random access memory (RAM) or other volatile memories.

The storage 12 stores programs and data. The storage 12 is achieved as, for example, a read-only memory (ROM), a hard disk device, a flash memory, or other non-volatile storage devices. The programs stored in the storage 12 include, for example, programs for providing a virtual space in the HMD system 100, simulation programs, game programs, user authentication programs, and programs for achieving communication to/from other computers 200. The data stored in the storage 12 includes data and objects for defining the virtual space.

In at least one aspect, the storage 12 may be achieved as a removable storage device like a memory card. In at least one aspect, a configuration that uses programs and data stored in an external storage device may be used instead of the storage 12 built into the computer 200. With such a configuration, for example, in a situation in which a plurality of HMD systems 100 are used as in an amusement facility, the programs, the data, and the like can be collectively updated.

According to at least one embodiment of this disclosure, the input/output interface 13 is configured to allow communication of signals among the HMD device 110, the HMD sensor 120, and the motion sensor 130. In at least one aspect, the input/output interface 13 is achieved with use of a universal serial bus (USB) interface, a digital visual interface (DVI), a high-definition multimedia interface (HDMI)®, or other terminals. The input/output interface 13 is not limited to ones described above.

According to at least one embodiment of this disclosure, the input/output interface 13 may further communicate to/from the controller 160. For example, the input/output interface 13 receives input of a signal output from the motion sensor 130. In at least one aspect, the input/output interface 13 transmits a command output from the processor 10 to the controller 160. The command instructs the controller 160 to vibrate, output a sound, emit light, or the like. When the controller 160 receives the command, the controller 160 executes any one of vibration, sound output, and light emission in accordance with the command.

The communication interface 14 is connected to the network 19 to communicate to/from other computers (for example, the server 150) connected to the network 19. In at least one aspect, the communication interface 14 is achieved as, for example, a local area network (LAN), other wired communication interfaces, wireless fidelity (Wi-Fi), Bluetooth®, near field communication (NFC), or other wireless communication interfaces. The communication interface 14 is not limited to ones described above.

In at least one aspect, the processor 10 accesses the storage 12 and loads one or more programs stored in the storage 12 to the memory 11 to execute a series of commands included in the program. The one or more programs may include, for example, an operating system of the computer 200, an application program for providing a virtual space, and game software that can be executed in the virtual space with use of the controller 160. The processor 10 transmits a signal for providing a virtual space to the HMD device 110 via the input/output interface 13. The HMD device 110 displays a video on the monitor 112 based on the signal.

In FIG. 2, the computer 200 is provided outside of the HMD device 110, but in at least one aspect, the computer 200 may be built into the HMD device 110. As an example, a portable information communication terminal (for example, a smart phone) including the monitor 112 may function as the computer 200.

The computer 200 may be used in common among a plurality of HMD devices 110. With such a configuration, for example, the same virtual space can be provided to a plurality of users, and hence each user can enjoy the same application with other users in the same virtual space.

According to at least one embodiment of this disclosure, in the HMD system 100, a global coordinate system is set in advance. The global coordinate system has three reference directions (axes) that are respectively parallel to a vertical direction, a horizontal direction orthogonal to the vertical direction, and a front-rear direction orthogonal to both of the vertical direction and the horizontal direction in a real space. In at least one embodiment, the global coordinate system is one type of point-of-view coordinate system. Hence, the horizontal direction, the vertical direction (up-down direction), and the front-rear direction in the global coordinate system are defined as an x axis, a y axis, and a z axis, respectively. More specifically, the x axis of the global coordinate system is parallel to the horizontal direction of the real space, the y axis thereof is parallel to the vertical direction of the real space, and the z axis thereof is parallel to the front-rear direction of the real space.

In at least one aspect, the HMD sensor 120 includes an infrared sensor. When the infrared sensor detects the infrared ray emitted from each light source of the HMD device 110, the infrared sensor detects the presence of the HMD device 110. The HMD sensor 120 further detects the position and the inclination of the HMD device 110 in the real space in accordance with the movement of the user 190 wearing the HMD device 110 based on the value of each point (each coordinate value in the global coordinate system). In more detail, the HMD sensor 120 can detect the temporal change of the position and the inclination of the HMD device 110 with use of each value detected over time.

The global coordinate system is parallel to a coordinate system of the real space. Therefore, each inclination of the HMD device 110 detected by the HMD sensor 120 corresponds to each inclination about each of the three axes of the HMD device 110 in the global coordinate system. The HMD sensor 120 sets a uvw visual-field coordinate system to the HMD device 110 based on the inclination of the HMD device 110 in the global coordinate system. The uvw visual-field coordinate system set to the HMD device 110 corresponds to a point-of-view coordinate system used when the user 190 wearing the HMD device 110 views an object in the virtual space.

[Uvw Visual-Field Coordinate System]

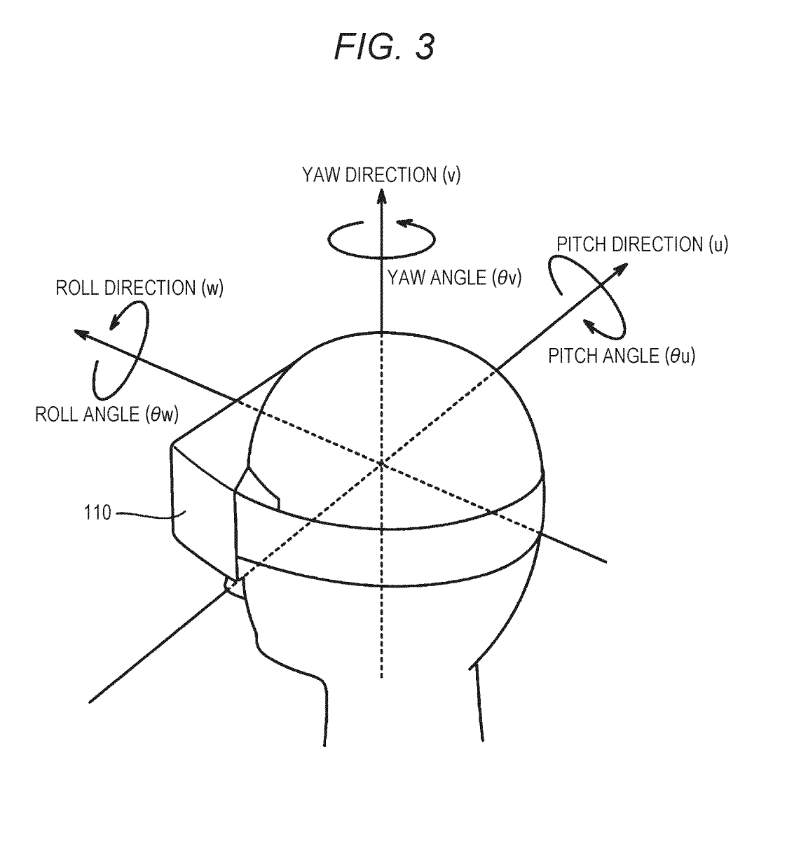

With reference to FIG. 3, the uvw visual-field coordinate system is described. FIG. 3 is a diagram of a uvw visual-field coordinate system to be set for the HMD device 110 of at least one embodiment of this disclosure. The HMD sensor 120 detects the position and the inclination of the HMD device 110 in the global coordinate system when the HMD device 110 is activated. The processor 10 sets the uvw visual-field coordinate system to the HMD device 110 based on the detected values.

In FIG. 3, the HMD device 110 sets the three-dimensional uvw visual-field coordinate system defining the head of the user wearing the HMD device 110 as a center (origin). More specifically, the HMD device 110 sets three directions newly obtained by inclining the horizontal direction, the vertical direction, and the front-rear direction (x axis, y axis, and z axis), which define the global coordinate system, about the respective axes by the inclinations about the respective axes of the HMD device 110 in the global coordinate system as a pitch direction (u axis), a yaw direction (v axis), and a roll direction (w axis) of the uvw visual-field coordinate system in the HMD device 110.

In at least one aspect, when the user 190 wearing the HMD device 110 is standing upright and is visually recognizing the front side, the processor 10 sets the uvw visual-field coordinate system that is parallel to the global coordinate system to the HMD device 110. In this case, the horizontal direction (x axis), the vertical direction (y axis), and the front-rear direction (z axis) of the global coordinate system match the pitch direction (u axis), the yaw direction (v axis), and the roll direction (w axis) of the uvw visual-field coordinate system in the HMD device 110, respectively.

After the uvw visual-field coordinate system is set to the HMD device 110, the HMD sensor 120 can detect the inclination (change amount of the inclination) of the HMD device 110 in the uvw visual-field coordinate system that is set based on the movement of the HMD device 110. In this case, the HMD sensor 120 detects, as the inclination of the HMD device 110, each of a pitch angle (θu), a yaw angle (θv), and a roll angle (θw) of the HMD device 110 in the uvw visual-field coordinate system. The pitch angle (θu) represents an inclination angle of the HMD device 110 about the pitch direction in the uvw visual-field coordinate system. The yaw angle (θv) represents an inclination angle of the HMD device 110 about the yaw direction in the uvw visual-field coordinate system. The roll angle (θw) represents an inclination angle of the HMD device 110 about the roll direction in the uvw visual-field coordinate system.

The HMD sensor 120 sets, to the HMD device 110, the uvw visual-field coordinate system of the HMD device 110 obtained after the movement of the HMD device 110 based on the detected inclination angle of the HMD device 110. The relationship between the HMD device 110 and the uvw visual-field coordinate system of the HMD device 110 is always constant regardless of the position and the inclination of the HMD device 110. When the position and the inclination of the HMD device 110 change, the position and the inclination of the uvw visual-field coordinate system of the HMD device 110 in the global coordinate system change in synchronization with the change of the position and the inclination.

In at least one aspect, the HMD sensor 120 may specify the position of the HMD device 110 in the real space as a position relative to the HMD sensor 120 based on the light intensity of the infrared ray or a relative positional relationship between a plurality of points (for example, a distance between the points), which is acquired based on output from the infrared sensor. The processor 10 may determine the origin of the uvw visual-field coordinate system of the HMD device 110 in the real space (global coordinate system) based on the specified relative position.

[Virtual Space]

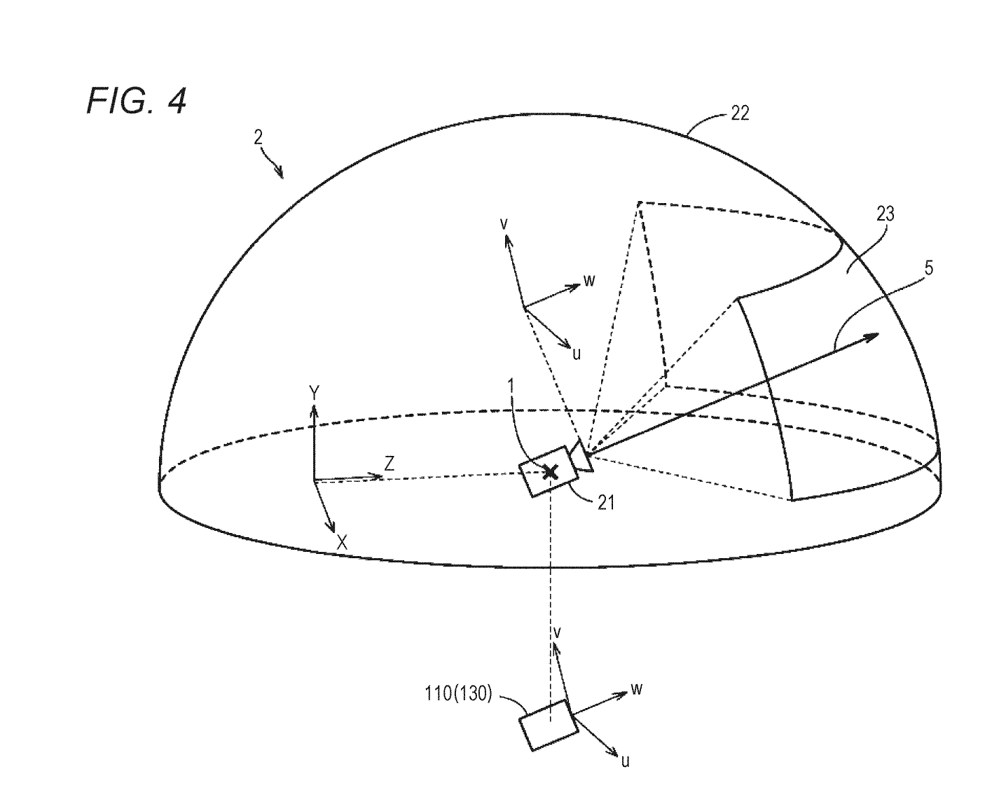

With reference to FIG. 4, the virtual space is further described. FIG. 4 is a diagram of a mode of expressing a virtual space 2 of at least one embodiment of this disclosure. The virtual space 2 has a structure with an entire celestial sphere shape covering a center 21 in all 360-degree directions. In FIG. 4, in order to avoid complicated description, only the upper-half celestial sphere of the virtual space 2 is exemplified. Each mesh section is defined in the virtual space 2. The position of each mesh section is defined in advance as coordinate values in an XYZ coordinate system defined in the virtual space 2. The computer 200 associates each partial image forming content (for example, still image or moving image) that can be developed in the virtual space 2 with each corresponding mesh section in the virtual space 2, to thereby provide to the user the virtual space 2 in which a virtual space image 22 that can be visually recognized by the user is developed.

In at least one aspect, in the virtual space 2, the XYZ coordinate system having the center 21 as the origin is defined. The XYZ coordinate system is, for example, parallel to the global coordinate system. The XYZ coordinate system is one type of the point-of-view coordinate system, and hence the horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the global coordinate system, the Y axis (vertical direction) of the XYZ coordinate system is parallel to they axis of the global coordinate system, and the Z axis (front-rear direction) of the XYZ coordinate system is parallel to the z axis of the global coordinate system.

When the HMD device 110 is activated, that is, when the HMD device 110 is in an initial state, a virtual camera 1 is arranged at the center 21 of the virtual space 2. In synchronization with the movement of the HMD device 110 in the real space, the virtual camera 1 similarly moves in the virtual space 2. With this, the change in position and direction of the HMD device 110 in the real space is reproduced similarly in the virtual space 2.

The uvw visual-field coordinate system is defined in the virtual camera 1 similarly to the case of the HMD device 110. The uvw visual-field coordinate system of the virtual camera in the virtual space 2 is defined to be synchronized with the uvw visual-field coordinate system of the HMD device 110 in the real space. Therefore, when the inclination of the HMD device 110 changes, the inclination of the virtual camera 1 also changes in synchronization therewith. The virtual camera 1 can also move in the virtual space 2 in synchronization with the movement of the user wearing the HMD device 110 in the real space.

The processor 10 defines a field-of-view region 23 in the virtual space 2 based on a reference line of sight 5. The field-of-view region 23 corresponds to, of the virtual space 2, the region that is visually recognized by the user wearing the HMD device 110.

The line-of-sight direction of the user 190 detected by the eye gaze sensor 140 is a direction in the point-of-view coordinate system obtained when the user 190 visually recognizes an object. The uvw visual-field coordinate system of the HMD device 110 is equal to the point-of-view coordinate system used when the user 190 visually recognizes the monitor 112. The uvw visual-field coordinate system of the virtual camera 1 is synchronized with the uvw visual-field coordinate system of the HMD device 110. Therefore, in the HMD system 100 in one aspect, the line-of-sight direction of the user 190 detected by the eye gaze sensor 140 can be regarded as the user's line-of-sight direction in the uvw visual-field coordinate system of the virtual camera 1.

[User's Line of Sight]

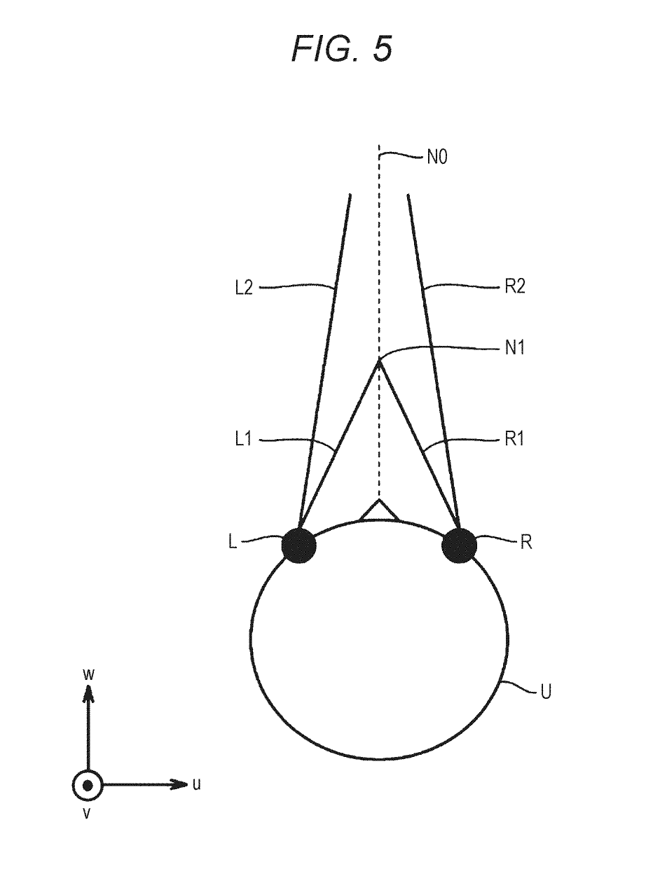

With reference to FIG. 5, determination of the user's line-of-sight direction is described. FIG. 5 is a top view diagram of a head of the user 190 wearing the HMD device 110 of at least one embodiment of this disclosure.

In at least one aspect, the eye gaze sensor 140 detects lines of sight of the right eye and the left eye of the user 190. In at least one aspect, when the user 190 is looking at a near place, the eye gaze sensor 140 detects lines of sight R1 and L1. In at least one aspect, when the user 190 is looking at a far place, the eye gaze sensor 140 detects lines of sight R2 and L2. In this case, the angles formed by the lines of sight R2 and L2 with respect to the roll direction w are smaller than the angles formed by the lines of sight R1 and L1 with respect to the roll direction w. The eye gaze sensor 140 transmits the detection results to the computer 200.

When the computer 200 receives the detection values of the lines of sight R1 and L1 from the eye gaze sensor 140 as the detection results of the lines of sight, the computer 200 specifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 specifies an intersection of both the lines of sight R2 and L2 as the point of gaze. The computer 200 identifies a line-of-sight direction NO of the user 190 based on the specified point of gaze N1. The computer 200 detects, for example, an extension direction of a straight line that passes through the point of gaze N1 and a midpoint of a straight line connecting a right eye R and a left eye L of the user 190 to each other as the line-of-sight direction NO. The line-of-sight direction NO is a direction in which the user 190 actually directs his or her lines of sight with both eyes. Further, the line-of-sight direction NO corresponds to a direction in which the user 190 actually directs his or her lines of sight with respect to the field-of-view region 23.

In at least one aspect, the HMD system 100 may include microphones and speakers in any part constructing the HMD system 100. When the user speaks to the microphone, an instruction can be given to the virtual space 2 with voice.

In at least one aspect, the HMD system 100 may include a television broadcast reception tuner. With such a configuration, the HMD system 100 can display a television program in the virtual space 2.

In at least one aspect, the HMD system 100 may include a communication circuit for connecting to the Internet or have a verbal communication function for connecting to a telephone line.

[Field-of-View Region]

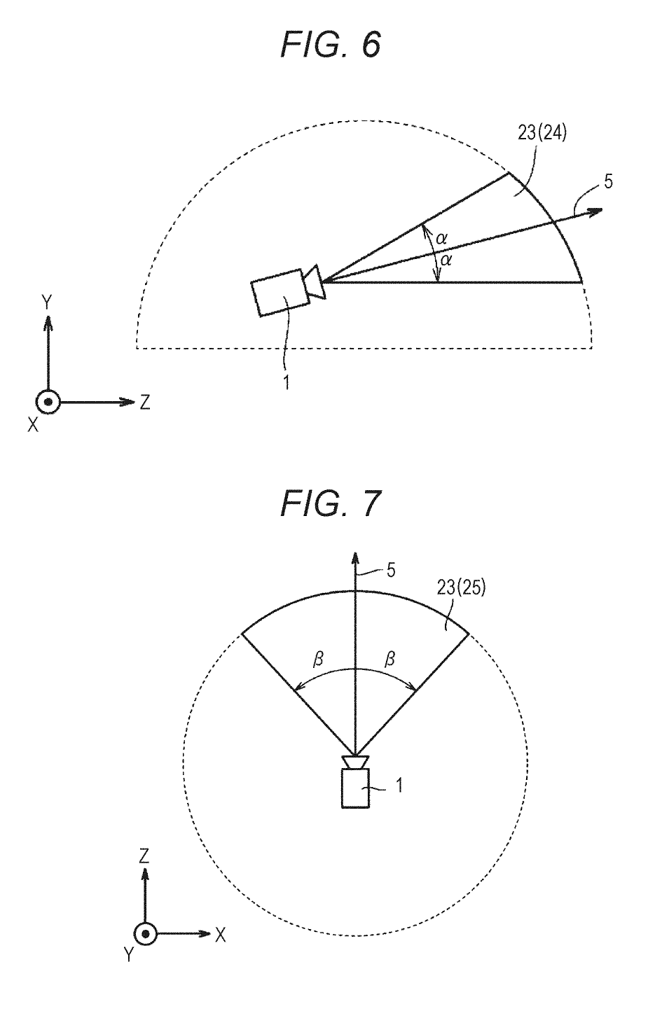

With reference to FIG. 6 and FIG. 7, the field-of-view region 23 is described. FIG. 6 is a diagram of a YZ cross section obtained by viewing the field-of-view region 23 from an X direction in the virtual space 2 of at least one embodiment. FIG. 7 is a diagram of an XZ cross section obtained by viewing the field-of-view region 23 from a Y direction in the virtual space 2 of at least one embodiment.

In FIG. 6, the field-of-view region 23 in the YZ cross section includes a region 24. The region 24 is defined by the reference line of sight 5 of the virtual camera 1 and the YZ cross section of the virtual space 2. The processor 10 defines a range of a polar angle α from the reference line of sight 5 serving as the center in the virtual space as the region 24.

As illustrated in FIG. 7, the field-of-view region 23 in the XZ cross section includes a region 25. The region 25 is defined by the reference line of sight 5 and the XZ cross section of the virtual space 2. The processor 10 defines a range of an azimuth β from the reference line of sight 5 serving as the center in the virtual space 2 as the region 25.

In at least one aspect, the HMD system 100 causes the monitor 112 to display a field-of-view image based on the signal from the computer 200, to thereby provide the virtual space to the user 190. The field-of-view image corresponds to a part of the virtual space image 22, which is superimposed on the field-of-view region 23. When the user 190 moves the HMD device 110 worn on his or her head, the virtual camera 1 is also moved in synchronization with the movement. As a result, the position of the field-of-view region 23 in the virtual space 2 is changed. With this, the field-of-view image displayed on the monitor 112 is updated to an image that is superimposed on the field-of-view region 23 of the virtual space image 22 in a direction in which the user faces in the virtual space 2. The user can visually recognize a desired direction in the virtual space 2.

While the user 190 is wearing the HMD device 110, the user 190 cannot visually recognize the real world but can visually recognize only the virtual space image 22 developed in the virtual space 2. The HMD system 100 can thus provide a high sense of immersion in the virtual space 2 to the user.

In at least one aspect, the processor 10 may move the virtual camera 1 in the virtual space 2 in synchronization with the movement in the real space of the user 190 wearing the HMD device 110. The processor 10 specifies the field-of-view region 23, which is an image region to be projected on the monitor 112 of the HMD device 110, based on the position and the direction of the virtual camera 1 in the virtual space 2. That is, a visual field of the user 190 in the virtual space 2 is defined by the virtual camera 1.

According to at least one embodiment of this disclosure, the virtual camera 1 is desired to include two virtual cameras, that is, a virtual camera for providing a right-eye image and a virtual camera for providing a left-eye image. In at least one embodiment, an appropriate parallax is set for the two virtual cameras so that the user 190 can recognize the three-dimensional virtual space 2. In this embodiment, a technical idea of this disclosure is exemplified assuming that the virtual camera 1 includes two virtual cameras, and the roll directions of the two virtual cameras are synthesized so that the generated roll direction (w) is adapted to the roll direction (w) of the HMD device 110.

[Controller]

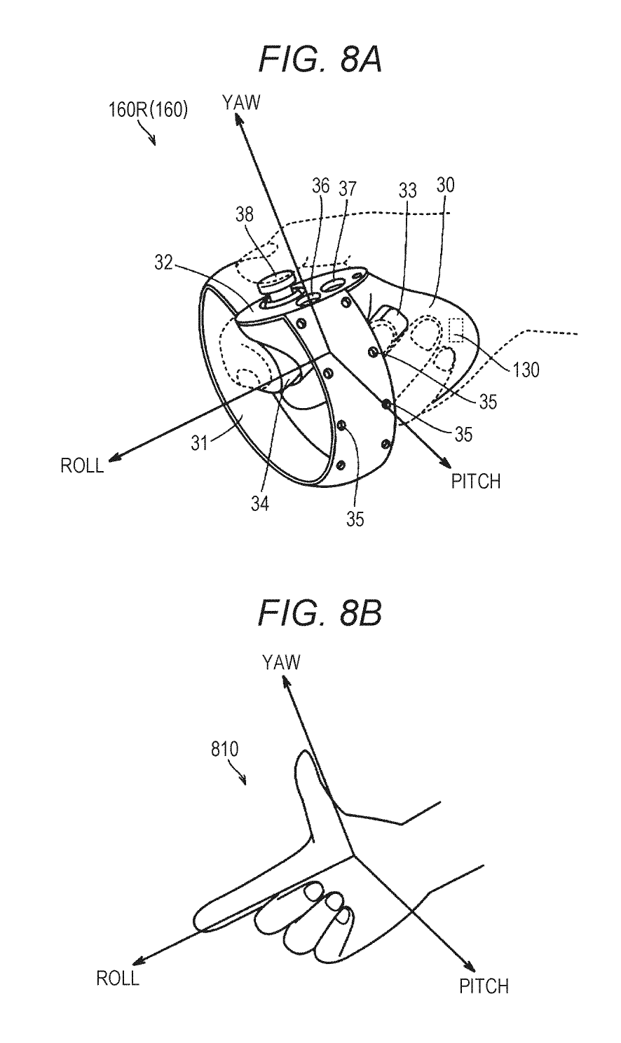

An example of the controller 160 is described with reference to FIGS. 8A and 8B. FIG. 8A is a diagram of a schematic configuration of the controller 160 of at least one embodiment of this disclosure. FIG. 8B is a diagram of a coordinate system for a user's hand of at least one embodiment.

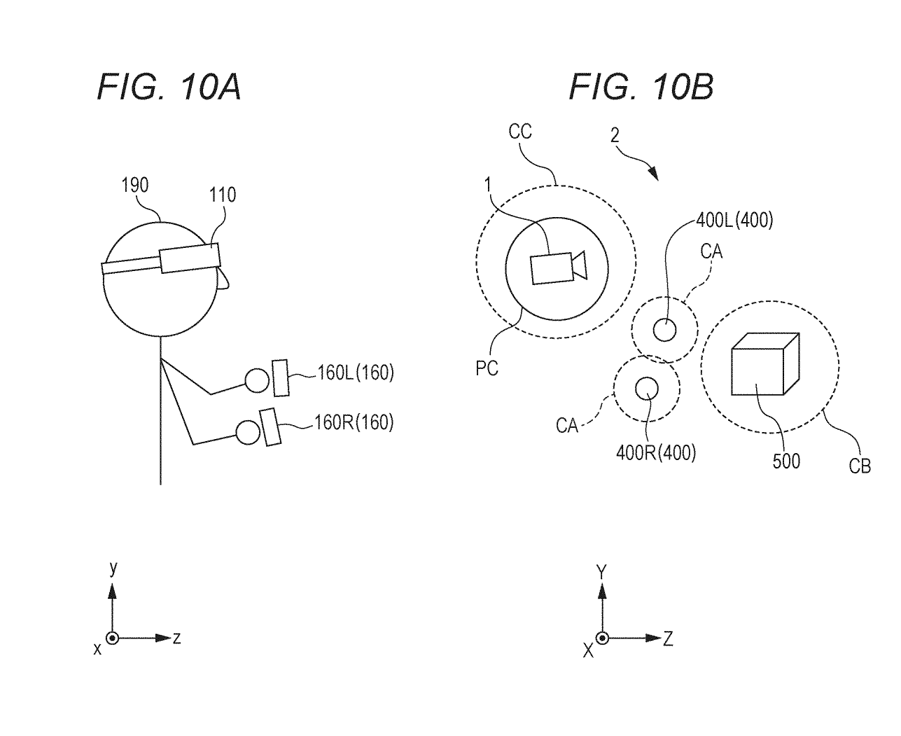

In FIG. 8A, in at least one aspect, the controller 160 may include a right controller 160R and a left controller 160L (see FIG. 10). The right controller 160R is operated by the right hand of the user 190. The left controller 160L is operated by the left hand of the user 190. In at least one aspect, the right controller 160R and the left controller 160L are symmetrically configured as separate devices. Therefore, the user 190 can freely move his or her right hand holding the right controller 160R and his or her left hand holding the left controller 160L. In at least one aspect, the controller 160 may be an integrated controller configured to receive an operation by both hands. The right controller 160R is now described.

The right controller 160R includes a grip 30, a frame 31, and a top surface 32. The grip 30 is configured so as to be held by the right hand of the user 190. For example, the grip 30 may be held by the palm and three fingers (middle finger, ring finger, and small finger) of the right hand of the user 190.

The grip 30 includes buttons 33 and 34 and the motion sensor 130. The button 33 is arranged on a side surface of the grip 30, and is configured to receive an operation performed by the middle finger of the right hand. The button 34 is arranged on a front surface of the grip 30, and is configured to receive an operation performed by the index finger of the right hand. In at least one aspect, the buttons 33 and 34 are configured as trigger type buttons. The motion sensor 130 is built into the casing of the grip 30. When a motion of the user 190 can be detected from the surroundings of the user 190 by a camera or other device, the grip 30 does not include the motion sensor 130 in at least one embodiment.

The frame 31 includes a plurality of infrared LEDs 35 arranged in a circumferential direction of the frame 31. The infrared LEDs 35 are configured to emit, during execution of a program using the controller 160, infrared rays in accordance with progress of that program. The infrared rays emitted from the infrared LEDs 35 may be used to detect the position, the posture (inclination and direction), and the like of each of the right controller 160R and the left controller 160L. In FIG. 8A, the infrared LEDs 35 are shown as being arranged in two rows, but the number of arrangement rows is not limited to the arrangement in FIG. 8A. The infrared LEDs 35 may be arranged in one row or in three or more rows.

The top surface 32 includes buttons 36 and 37 and an analog stick 38. The buttons 36 and 37 are configured as push type buttons. The buttons 36 and 37 are configured to receive an operation performed by the thumb of the right hand of the user 190. In at least one aspect, the analog stick 38 is configured to receive an operation in any direction of 360 degrees from an initial position. That operation includes, for example, an operation for moving an object arranged in the virtual space 2.

In at least one aspect, the right controller 160R and the left controller 160L each include a battery for driving the infrared ray LEDs 35 and other members. The battery includes, for example, a rechargeable battery, a button battery, a dry battery, but the battery is not limited thereto. In at least one aspect, the right controller 160R and the left controller 160L can be connected to a USB interface of the computer 200. In this case, each of the right controller 160R and the left controller 160L does not need a battery.

In FIG. 8B, for example, respective directions of yaw, roll, and pitch are defined for a right hand 810 of the user 190. When the user 190 stretches the thumb and the index finger, a direction in which the thumb is stretched is defined as the yaw direction, a direction in which the index finger is stretched is defined as the roll direction, and a direction orthogonal to a plane defined by the axis of the yaw direction and the axis of the roll direction is defined as the pitch direction.

[Control Device of HMD Device]

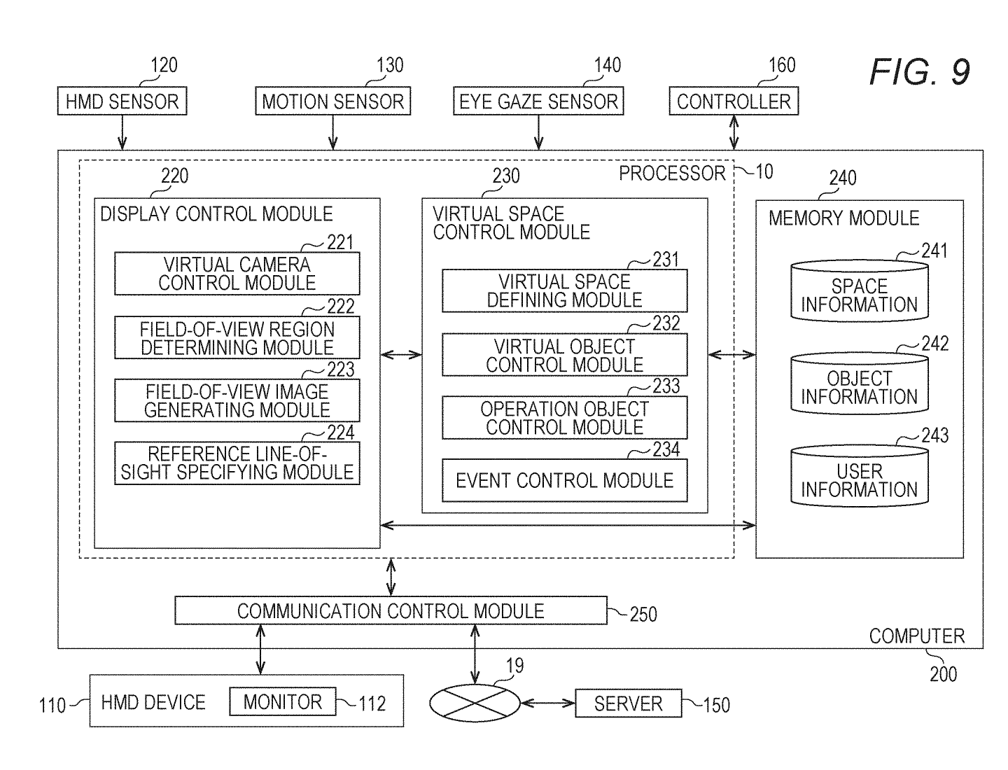

With reference to FIG. 9, the control device of the HMD device 110 is described. According to at least one embodiment of this disclosure, the control device is achieved by the computer 200 having a known configuration. FIG. 9 is a block diagram of a module configuration of the computer 200 of at least one embodiment of this disclosure.

In FIG. 9, the computer 200 includes a display control module 220, a virtual space control module 230, a memory module 240, and a communication control module 250. The display control module 220 includes, as sub-modules, a virtual camera control module 221, a field-of-view region determining module 222, a field-of-view image generating module 223, and a reference line-of-sight specifying module 224. The virtual space control module 230 includes, as sub-modules, a virtual space defining module 231, a virtual object control module 232, and an operation object control module 233, and an event control module 234.

According to at least one embodiment of this disclosure, the display control module 220 and the virtual space control module 230 are achieved by the processor 10. According to at least one embodiment of this disclosure, a plurality of processors 10 may actuate as the display control module 220 and the virtual space control module 230. The memory module 240 is achieved by the memory 11 or the storage 12. The communication control module 250 is achieved by the communication interface 14.

In at least one aspect, the display control module 220 is configured to control the image display on the monitor 112 of the HMD device 110. The virtual camera control module 221 is configured to arrange the virtual camera 1 in the virtual space 2, and to control the behavior, the direction, and the like of the virtual camera 1. The field-of-view region determining module 222 is configured to define the field-of-view region 23 in accordance with the direction of the head of the user wearing the HMD device 110. The field-of-view image generating module 223 is configured to generate the field-of-view image to be displayed on the monitor 112 based on the determined field-of-view region 23. The reference line-of-sight specifying module 224 is configured to specify the line of sight of the user 190 based on the signal from the eye gaze sensor 140.

The virtual space control module 230 is configured to control the virtual space 2 to be provided to the user 190. The virtual space defining module 231 is configured to generate virtual space data representing the virtual space 2 to define the virtual space 2 in the HMD system 100.

The virtual object control module 232 is configured to generate a target object to be arranged in the virtual space 2. The virtual object control module 232 is configured to control actions (movement, change in state, and the like) of the target object and the character object in the virtual space 2. Examples of the target object may include forests, mountains, other landscapes, and animals to be arranged in accordance with the progress of the story of the game. The character object represents an object (so-called avatar) associated with the user 190 in the virtual space 2. Examples of the character object include an object formed to have a shape of a human. The character object may wear equipment objects (for example, a weapon object and a protector object that imitate equipment items being a weapon and a protector, respectively) being kinds of items used in the game situated in the virtual space 2.

The operation object control module 233 is configured to arrange in the virtual space 2 an operation object for operating an object arranged in the virtual space 2. In at least one aspect, examples of the operation object may include a hand object corresponding to a hand of the user wearing the HMD device 110, a finger object corresponding to a finger of the user, and a stick object corresponding to a stick to be used by the user. When the operation object is a finger object, in particular, the operation object corresponds to a portion of an axis in the direction indicated by that finger. The operation object may be a part (for example, a part corresponding to the hand) of the character object. The above-mentioned equipment object can also be worn on the operation object.

When any of the objects arranged in the virtual space 2 has collided with another object, the virtual space control module 230 detects that collision. The virtual space control module 230 can detect, for example, the timing of a given object touching another object, and performs processing determined in advance when the timing is detected. The virtual space control module 230 can detect the timing at which objects that are touching separate from each other, and performs processing determined in advance when the timing is detected. The virtual space control module 230 can also detect a state in which objects are touching. Specifically, when the operation object and another object are touching, the operation object control module 233 detects that the operation object and the other object have touched, and performs processing determined in advance.

The event control module 234 is configured to execute processing for generating, when an operation determined in advance and performed on a target object is detected, an event advantageous or disadvantageous to the user 190 in the game situated in the virtual space 2 depending on an attribute (first attribute information) associated with the target object. The processing is described later in detail.

The memory module 240 stores data to be used for providing the virtual space 2 to the user 190 by the computer 200. In one aspect, the memory module 240 stores space information 241, object information 242, and user information 243. The space information 241 stores one or more templates defined for providing the virtual space 2. The object information 242 includes, for example, content to be played in the virtual space 2 and information for arranging an object to be used in the content in the virtual space 2. Examples of the content may include a game and content representing a landscape similar to that of the real world. The object information 242 includes information (first attribute information and third attribute information that are described later) representing attributes associated with the respective objects (target object, operation object, and the like). The attributes may be determined in advance for the above-mentioned content, or may be changed in accordance with the progress status of the above-mentioned content. The user information 243 includes, for example, a program for causing the computer 200 to function as the control device of the HMD system 100 and an application program that uses each piece of content stored in the object information 242. In at least one embodiment, the user information 243 includes information (second attribute information described later) representing an attribute associated with the user 190 of the HMD device 110.

The data and programs stored in the memory module 240 are input by the user of the HMD device 110. Alternatively, the processor 10 downloads the programs or data from a computer (for example, the server 150) that is managed by a business operator providing the content, to thereby store the downloaded programs or data in the memory module 240.

The communication control module 250 may communicate to/from the server 150 or other information communication devices via the network 19.

In at least one aspect, the display control module 220 and the virtual space control module 230 may be achieved with use of, for example, Unity® provided by Unity Technologies. In at least one aspect, the display control module 220 and the virtual space control module 230 may also be achieved by combining the circuit elements for achieving each step of processing.

The processing in the computer 200 is achieved by hardware and software executed by the processor 10. The software may be stored in advance on a hard disk or other memory module 240. The software may also be stored on a compact disc read-only memory (CD-ROM) or other computer-readable non-volatile data recording medium, and distributed as a program product. The software may also be provided as a program product that can be downloaded by an information provider connected to the Internet or other network. Such software is read from the data recording medium by an optical disc drive device or other data reading device, or is downloaded from the server 150 or other computer via the communication control module 250 and then temporarily stored in the memory module 240. The software is read from the memory module 240 by the processor 10, and is stored in a RAM in a format of an executable program. The processor 10 executes that program.

The hardware constructing the computer 200 in FIG. 9 is common hardware. Therefore, a component of at least one embodiment includes the program stored in the computer 200. One of ordinary skill in the art would understand the operations of the hardware of the computer 200, and hence a detailed description thereof is omitted here.

The data recording medium is not limited to a CD-ROM, a flexible disk (FD), and a hard disk. The data recording medium may also be a non-volatile data recording medium configured to store a program in a fixed manner, for example, a magnetic tape, a cassette tape, an optical disc (magnetic optical (MO) disc, mini disc (MD), or digital versatile disc (DVD)), an integrated circuit (IC) card (including a memory card), an optical card, and semiconductor memories such as a mask ROM, an erasable programmable read-only memory (EPROM), an electrically erasable programmable read-only memory (EEPROM), and a flash ROM.

The program does not only include a program that can be directly executed by the processor 10. The program may also include a program in a source program format, a compressed program, or an encrypted program, for example.

Processing for determining by the virtual space control module 230 whether or not the operation object and another object have touched each other is described in detail with reference to FIGS. 10A and 10B. FIG. 10A is a diagram of the user 190 wearing the HMD device 110 and the controller 160 of a least one embodiment. FIG. 10B is a diagram of the virtual space 2 that includes the virtual camera 1, the hand object 400, and the target object 500 of at least one embodiment.

In FIGS. 10A and 10B, the virtual space 2 includes the virtual camera 1, a player character PC (character object), the left hand object 400L, the right hand object 400R, and the target object 500. In at least one embodiment, the visual field of the player character PC matches the visual field of the virtual camera 1. This provides the user with a field-of-view image to be viewed from a first-person point of view. As described above, the virtual space defining module 231 of the virtual space control module 230 is configured to generate the virtual space data for defining the virtual space 2 that includes such objects. As described above, the virtual camera 1 is synchronized with the movement of the HMD device 110 worn by the user U. That is, the visual field of the virtual camera 1 is updated based on the movement of the HMD device 110. The right hand object 400R is the operation object configured to move in accordance with movement of the right controller 160R worn on the right hand of the user 190. The left hand object 400L is the operation object configured to move in accordance with movement of the left controller 160L worn on the left hand of the user 190. In the following, each of the left hand object 400L and the right hand object 400R may simply be referred to as “hand object 400” for the sake of convenience of description.

The left hand object 400L and the right hand object 400R each have a collision area CA. The target object 500 has a collision area CB. The player character PC has a collision area CC. The collision areas CA, CB, and CC are used for determination of collision between the respective objects. For example, when the collision area CA of the hand object 400 and the collision area CB of the target object 500 each have an overlapped area, the hand object 400 and the target object 500 are determined to have touched each other. In FIGS. 10A and 10B, each of the collision areas CA, CB, and CC may be defined by a sphere having a coordinate position set for each object as a center and having a predetermined radius R.

[Control Structure]

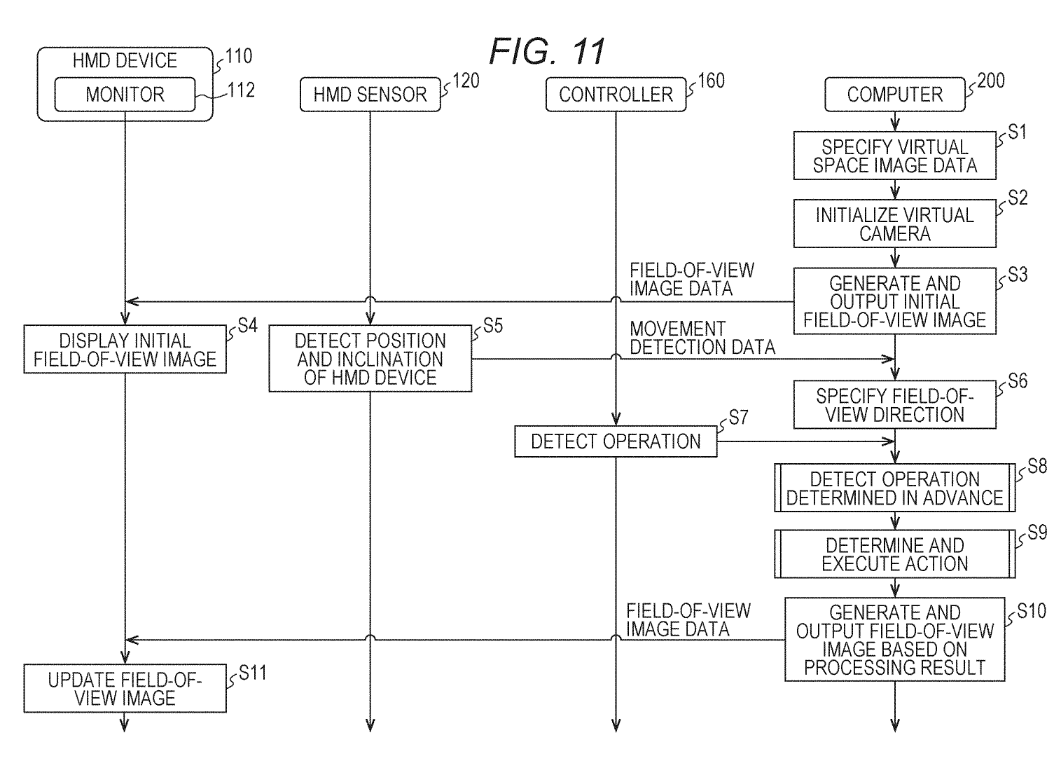

The control structure of the computer 200 of at least one embodiment is now described with reference to FIG. 11. FIG. 11 is a flowchart of processing to be executed by the HMD system 100 of at least one embodiment.

In Step S1, the processor 10 of the computer 200 serves as the virtual space defining module 231 to specify the virtual space image data and define the virtual space 2.

In Step S2, the processor 10 serves as the virtual camera control module 221 to initialize the virtual camera 1. For example, in a work area of the memory, the processor 10 arranges the virtual camera 1 at the center point defined in advance in the virtual space 2, and matches the line of sight of the virtual camera 1 with the direction in which a view of the user 190 is facing in the virtual space 2.

In Step S3, the processor 10 serves as the field-of-view image generating module 223 to generate field-of-view image data for displaying an initial field-of-view image. The generated field-of-view image data is transmitted to the HMD device 110 by the communication control module 250 via the field-of-view image generating module 223.

In Step S4, the monitor 112 of the HMD device 110 displays the field-of-view image based on the signal received from the computer 200. The user 190 wearing the HMD device 110 may recognize the virtual space 2 through visual recognition of the field-of-view image.

In Step S5, the HMD sensor 120 detects the inclination of the HMD device 110 based on a plurality of infrared rays emitted from the HMD device 110. The detection result is transmitted to the computer 200 as movement detection data.

In Step S6, the processor 10 serves as the field-of-view region determining module 222 to specify a field-of-view direction of the user 190 wearing the HMD device 110 based on the position and the inclination of the HMD device 110. The processor 10 executes an application program to arrange the objects in the virtual space 2 based on an instruction included in the application program.

In Step S7, the controller 160 detects an operation performed by the user 190 in the real space. For example, in at least one aspect, the controller 160 detects the fact that the button has been pressed by the user 190. In at least one aspect, the controller 160 detects the movement of both hands of the user 190 (for example, waving both hands). The detection signal representing the details of detection is transmitted to the computer 200.

In Step S8, the processor 10 serves as the operation object control module 233 to move the hand object 400 based on a signal representing the details of detection, which is transmitted from the controller 160. The processor 10 serves as the operation object control module 233 to detect the operation determined in advance and performed on the target object 500 by the hand object 400.

In Step S9, the processor 10 serves as the virtual object control module 232 or the virtual camera control module 221 to determine an action to be executed based on, for example, the attribute of the target object 500 set as the target of the operation determined in advance, and to cause at least one of the virtual camera 1 or the target object 500 to execute the action.

In Step S10, the processor 10 serves as the field-of-view region determining module 222 and the field-of-view image generating module 223 to generate the field-of-view image data for displaying the field-of-view image based on the result of the processing, and to output the generated field-of-view image data to the HMD device 110.

In Step S11, the monitor 112 of the HMD device 110 updates the field-of-view image based on the received field-of-view image data, and displays the updated field-of-view image.

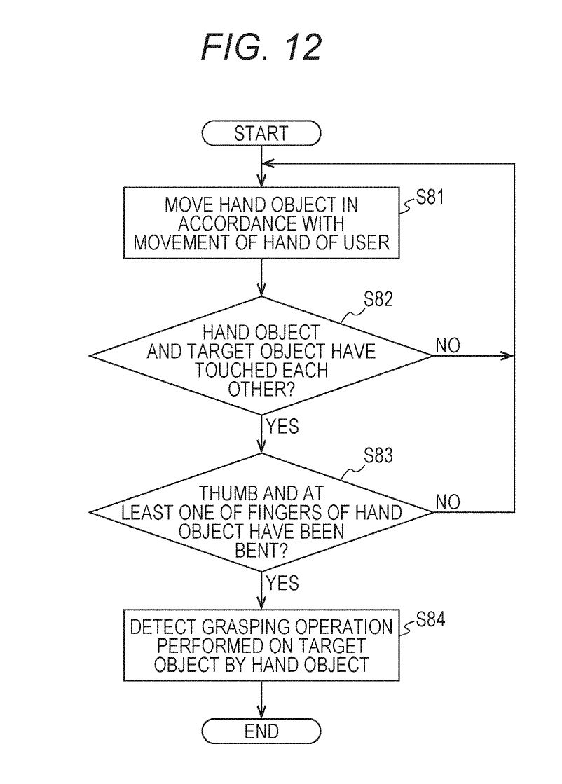

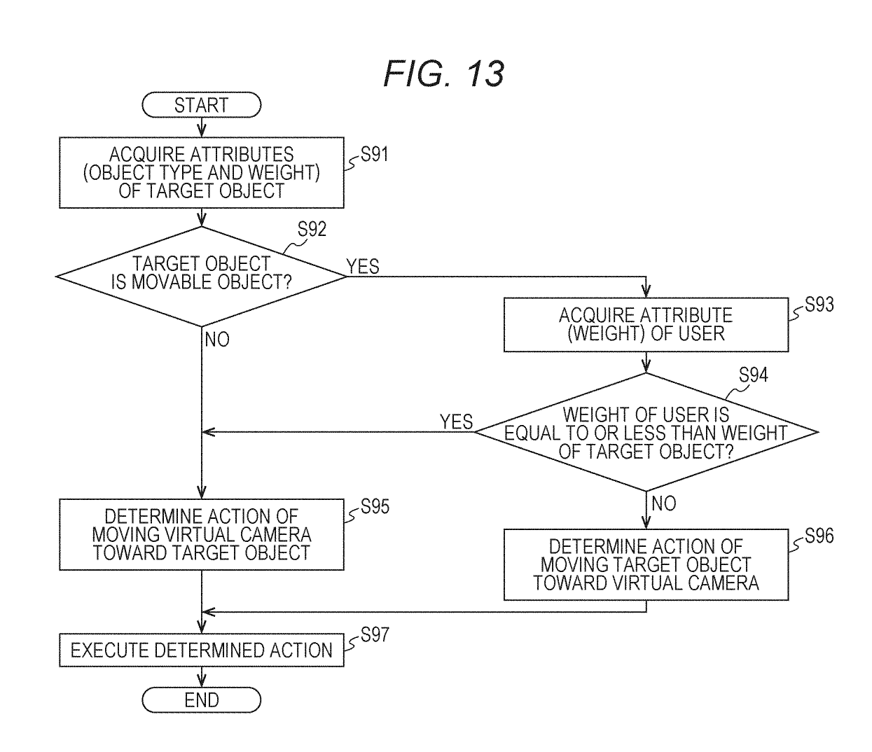

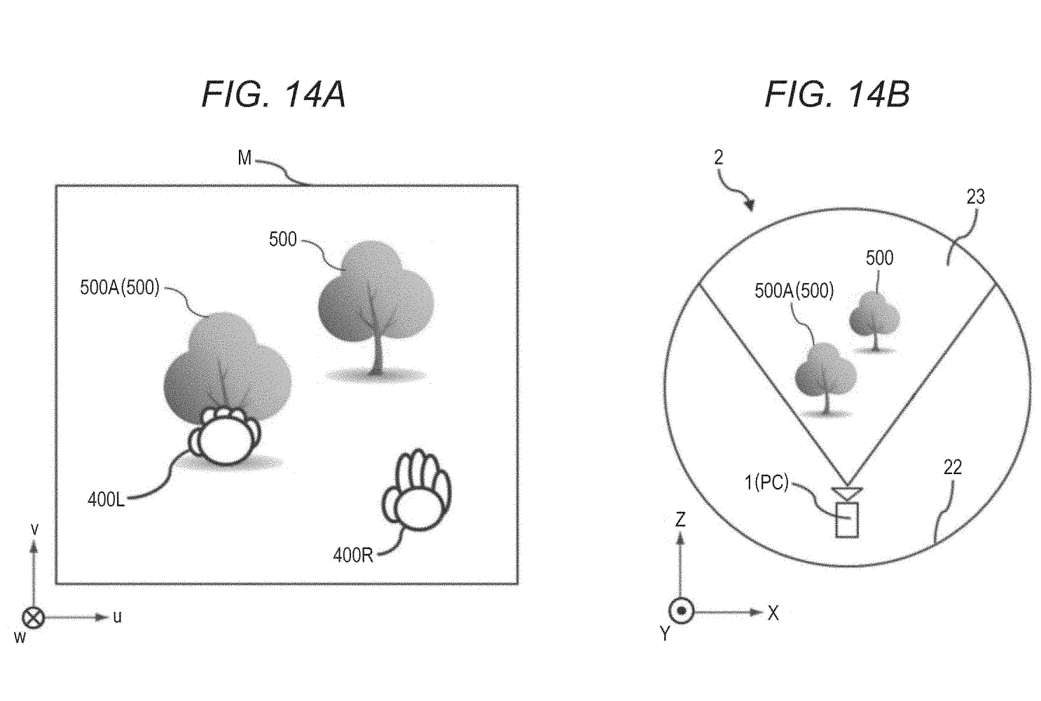

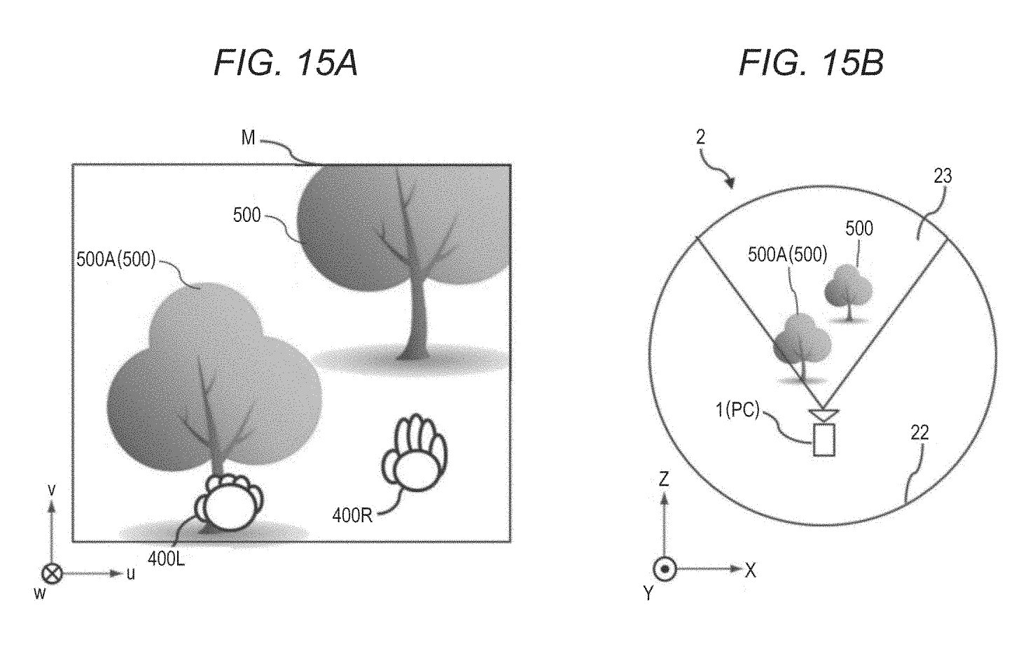

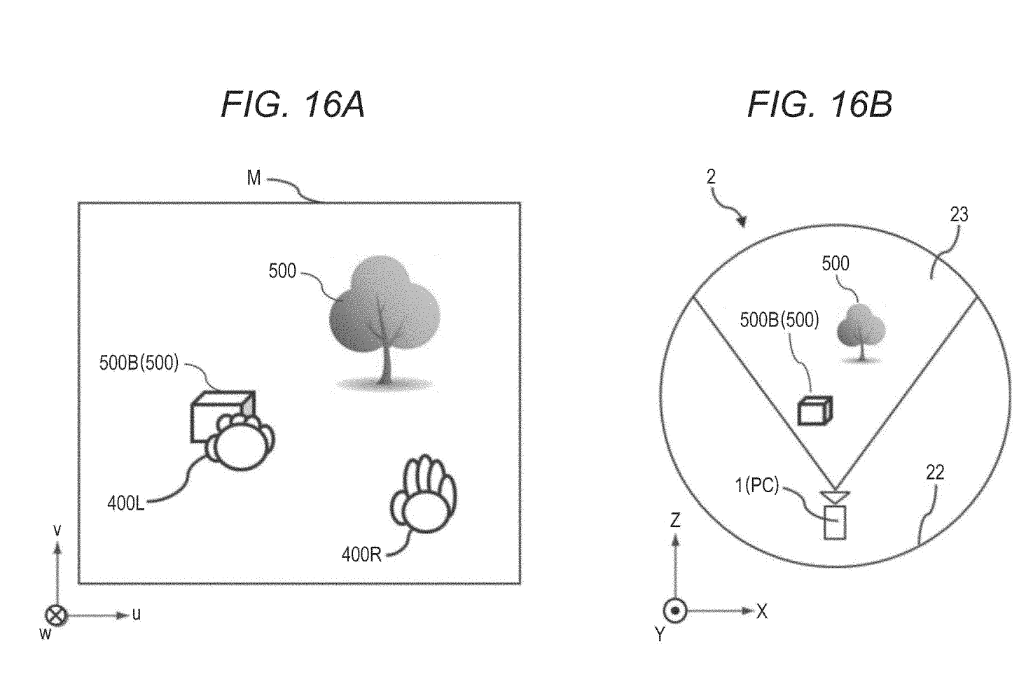

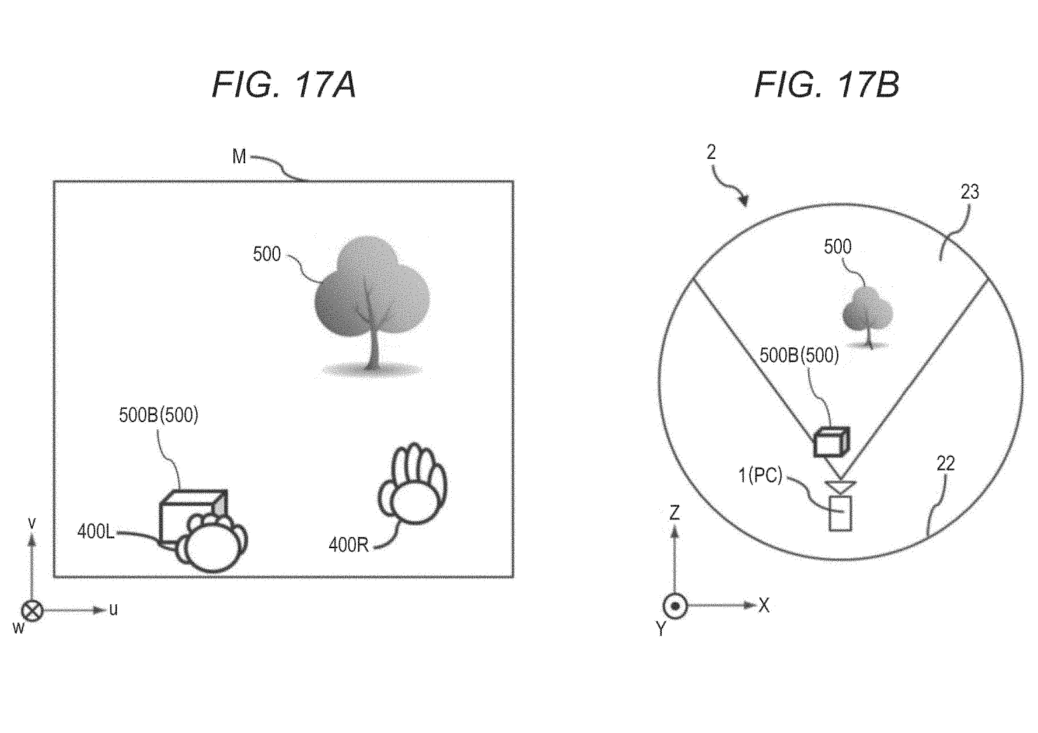

Details of the above-mentioned processing of Step S8 and Step S9 are described with reference to FIG. 12 to FIG. 17 according to at least one embodiment. FIG. 12 is a flowchart of the processing of Step S8 in FIG. 11 of at least one embodiment. FIG. 13 is a flowchart of the processing of Step S9 of FIG. 11 of at least one embodiment. FIG. 14A and FIG. 15A are diagrams of a field of view image of a first action according to at least one embodiment. FIG. 14B and FIG. 15B are diagrams of a virtual space of a first action according to at least one embodiment. FIG. 16A and FIG. 17A are diagrams of a field of view image of a second action according to at least one embodiment. FIG. 16B and FIG. 17B are diagrams of a virtual space of a second action according to at least one embodiment. In each of FIG. 14A to FIG. 17A, include a field-of-view image M, and FIG. 14B to FIG. 17B include the virtual space 2 from a Y direction. In at least one embodiment, when an operation of grasping the target object 500 by the hand object 400 (hereinafter referred to as “grasping operation”) is detected, the processor 10 determines and executes an action corresponding to the attribute of the target object 500 (first attribute information) and the attribute of the user 190 (second attribute information).

The processing of Step S8 of FIG. 11 performed in at least one embodiment is described in detail with reference to FIG. 12. In Step S81, the processor 10 moves the hand object 400 in the virtual space 2 in accordance with the movement of the hand of the user 190 detected by the controller 160.

In Step S82, the processor 10 determines whether or not the hand object 400 and the target object 500 have touched each other based on the collision area CA set for the hand object 400 and the collision area CB set for the target object 500. In response to a determination that the hand object 400 and the target object 500 have touched each other (YES in Step S82), in Step S83, the processor 10 determines whether or not a movement for grasping the target object 500 has been input to the hand object 400. For example, the processor 10 determines whether or not the movement of the hand object 400 includes a movement for moving the thumb and any one of the opposing fingers (at least one of the index finger, the middle finger, the ring finger, or the little finger) from a stretched state to a bent state. In response to a determination that the above-mentioned movement is included (YES in Step S83), in Step S84, the processor 10 detects the grasping operation performed on the target object 500 by the hand object 400. Meanwhile, in response to a determination that the hand object 400 and the target object 500 have touched each other (NO in Step S82) or in response to a determination that the above-mentioned movement is not included (NO in Step S83), the processor 10 continues to wait for movement information on the hand of the user 190, and to control the movement of the hand object 400.

The action of changing the state of the fingers of the hand object 400 is achieved by, for example, a predetermined operation performed on the controller 160 (see FIG. 8A) by the user 190. For example, when the button 34 is pressed, the processor 10 may change the index finger of the hand object 400 from a stretched state to a bent state. When the button 33 is pressed, the processor 10 may change the middle finger, the ring finger, and the little finger of the hand object 400 from a stretched state to a bent state. When the thumb is positioned on the top surface 32 or when any one of the buttons 36 and 37 is pressed, the processor 10 may change the thumb of the hand object 400 from a stretched state to a bent state.

When the grasping operation is detected in Step S84, Step S9 is executed. The processing of Step S9 of at least one embodiment is described in detail with reference to FIG. 13.

In Step S91, the processor 10 acquires the first attribute information representing the attribute associated with the target object 500 set as the target of the grasping operation. The processor 10 can refer to the object information 242 described above to acquire the first attribute information. In this case, the first attribute information includes object type information representing the type of the target object 500 and information representing the weight of the target object 500. The object type information is information indicating whether the target object 500 is a movable object set so as to be movable in the virtual space 2 or a stationary object set so as to be immovable in the virtual space 2.

In Step S92, the processor 10 refers to the first attribute information acquired in Step S91 to determine whether the target object 500 is a movable object or a stationary object. When the target object 500 is a movable object (YES in Step S92), in Step S93, the processor 10 acquires the second attribute information representing the attribute associated with the user 190. In this case, the attribute associated with the user 190 can be used as an attribute associated with the player character PC corresponding to the user 190 in the virtual space 2. The processor 10 can refer to the user information 243 to acquire the second attribute information. In this case, the second attribute information includes information on the weight of the user 190 or the player character PC. Subsequently, in Step S94, the processor 10 compares the weight of the user 190 and the weight of the target object 500.

When the target object 500 is a stationary object (NO in Step S92) or when the weight of the user 190 is equal to or less than the weight of the target object 500 (YES in Step S94), the processor 10 executes the processing of Step S95. In Step S95, the processor 10 determines an action of moving the virtual camera 1 toward the target object 500 without moving the target object 500. That is, the processor 10 determines the action of moving toward the target object 500 as an action to be executed, and determines the virtual camera 1 as an execution subject of the action.

When the target object 500 is a movable object (YES in Step S92) and when the weight of the user 190 is greater than the weight of the target object 500 (NO in Step S94), the processor 10 executes the processing of Step S96. In Step S96, the processor 10 determines an action of moving the target object 500 toward the virtual camera 1 without moving the virtual camera 1. That is, the processor 10 determines the action of moving toward the virtual camera 1 as an action to be executed, and determines the target object 500 as an execution subject of the action.

In Step S97, the processor 10 causes the virtual camera 1 or the target object 500 determined as the execution subject to execute the action determined in Step S95 or Step S96. The processor 10 serves as the virtual object control module 232 to execute Step S91 to Step S96. When the action of moving the virtual camera 1 is determined in Step S95, the processor 10 serves as the virtual camera control module 221 to execute Step S97 (moving the virtual camera 1). When the action of moving the target object 500 is determined in Step S96, the processor 10 serves as the virtual object control module 232 to execute Step S97 (moving the target object 500).

The first action according to at least one embodiment is described with reference to FIGS. 14A-B and FIGS. 15A-B. FIGS. 14A-B are diagrams of of a state immediately after the grasping operation performed by the left hand object 400L on a target object 500A representing a tree being a stationary object (or another object heavier than the user 190) is detected. In this case, when Step S95 and Step S97 described above and Step S10 and Step S11 of FIG. 11 are executed, the virtual space 2 in FIG. 15B is provided to the user 190. Specifically, the field-of-view image M obtained after moving the virtual camera 1 toward the target object 500A is provided to the user 190 via the monitor 112 of the HMD device 110, as in FIG. 15A.

With the action of thus drawing the virtual camera 1 toward the target object 500, the user 190 is provided with a sense of moving through use of his or her hand in the virtual space 2. Therefore, with such an action, the user is provided with a virtual experience in moving with the power of his or her hand, for example, bouldering.

The second action is described with reference to FIGS. 16A-B and FIGS. 17A-B. FIGS. 16A-B are diagrams of a state immediately after the grasping operation performed by the left hand object 400L on a target object 500B representing a box being a movable object and an object lighter than the user 190 is detected. In this case, when Step S95 and Step S97 described above and Step S10 and Step S11 of FIG. 11 are executed, the virtual space 2 in FIG. 17B is provided to the user 190. Specifically, the field-of-view image M obtained after moving the target object 500B toward the virtual camera 1 is provided to the user 190 via the monitor 112 of the HMD device 110, as in FIG. 17A.

As described above, in at least one embodiment, when determining that the user 190 (player character PC) can move the target object 500, the processor 10 determines and executes an action of drawing the target object 500 toward the virtual camera 1. Meanwhile, when determining that the user 190 cannot move the target object 500, the processor 10 determines and executes an action of drawing the player character PC (or virtual camera 1) toward the target object 500. That is, the processor 10 can determine an action based on a relationship between the attribute (object type information and weight) of the target object 500 and the attribute of the user 190 (player character PC). With this, variations of actions to be executed are increased, and the user 190 is provided with the virtual experience exhibiting a high entertainment value. As a result, the sense of immersion of the user 190 in the virtual space 2 can be improved.

In at least one embodiment, various changes can be made. For example, the processor 10 may determine the action to be executed and the execution subject of the action based on only the first attribute information (for example, the object type information). For example, when the target object 500 set as the target of the grasping operation is a movable object, the processor 10 may omit the comparison of the weights (Step S94 of FIG. 13), and immediately determine the action of moving the target object 500 toward the virtual camera 1. In this case, the processor 10 can determine the action to be executed and the execution subject of the action by simple processing for determining the attribute of the target object 500.

The attributes used for the determination above are not limited to the above-mentioned attributes. For example, the processor 10 may use a power (for example, a grasping power) of the user 190 as the second attribute information in place of the weight of the user 190 or together with the weight of the user 190. In this case, the processor 10 may determine the action of moving the target object 500 toward the virtual camera 1 when, for example, the power of the user 190 is equal to or larger than a predetermined threshold value corresponding to the weight of the target object 500.

The processor 10 may also determine a moving speed of the target object 500 or the virtual camera 1 as a part of information for defining the action to be executed based on the attribute (weight, power, and the like) of the user 190 and the attribute (object type, weight, and the like) of the target object 500. For example, when the target object 500 is a stationary object, the moving speed of the virtual camera 1 may be determined so as to become higher as the weight of the user 190 becomes less (and/or as the power of the user 190 becomes higher). Meanwhile, when the target object 500 is a movable object and the action of moving the target object 500 toward the virtual camera 1 is determined, the moving speed of the target object 500 may be determined so as to become higher as the weight of the target object 500 becomes less (and/or as the power of the user 190 becomes higher). Through use of the moving speed that differs depending on the magnitude or the like of an attribute value in this manner, the user 190 is provided with a virtual experience closer to reality.

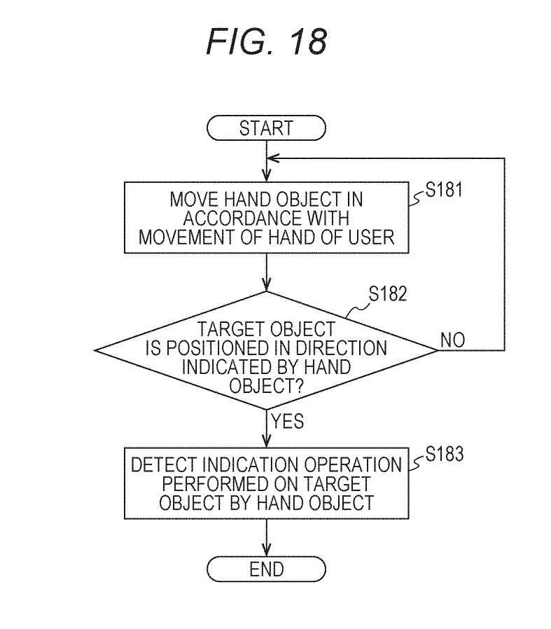

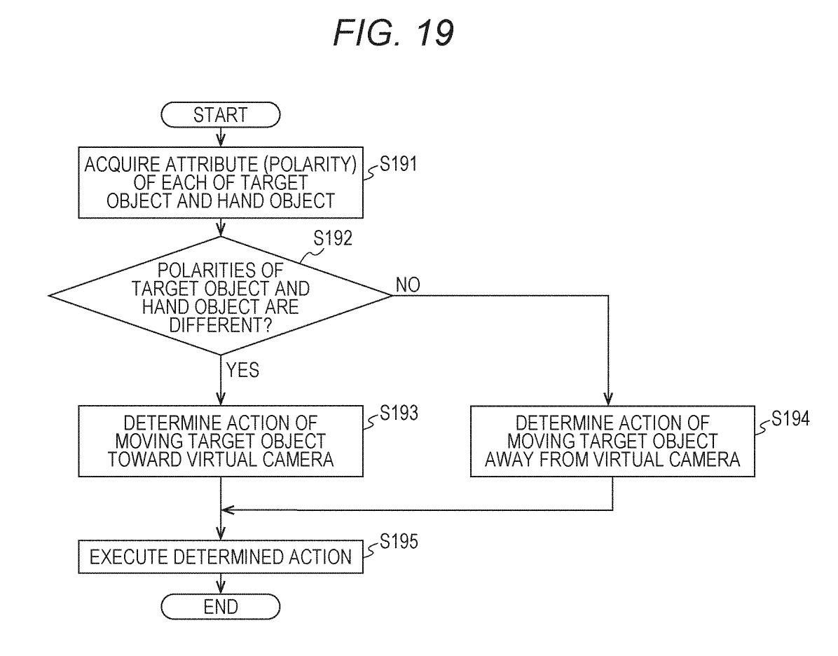

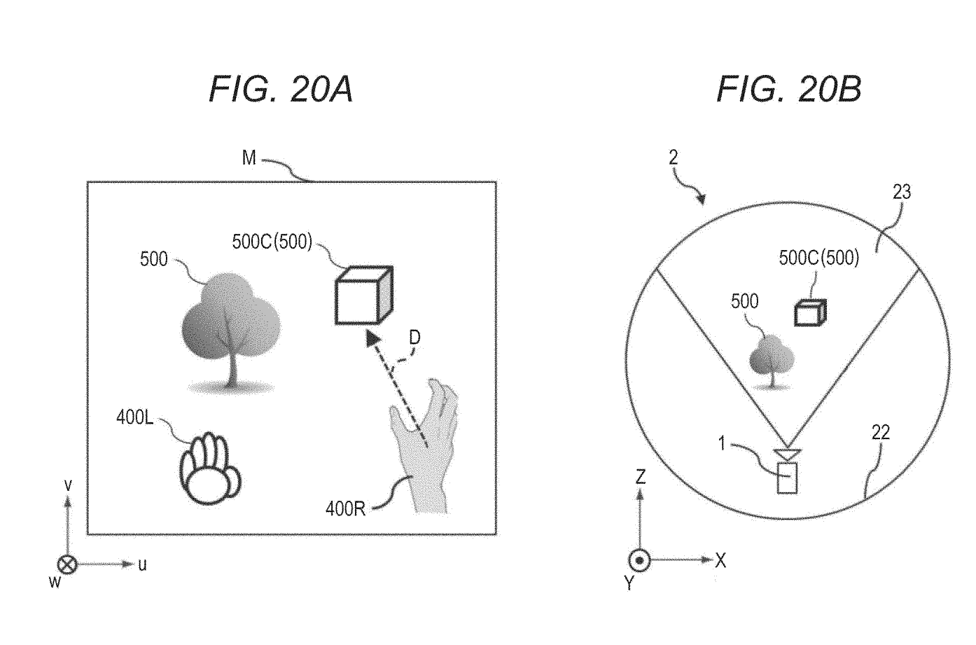

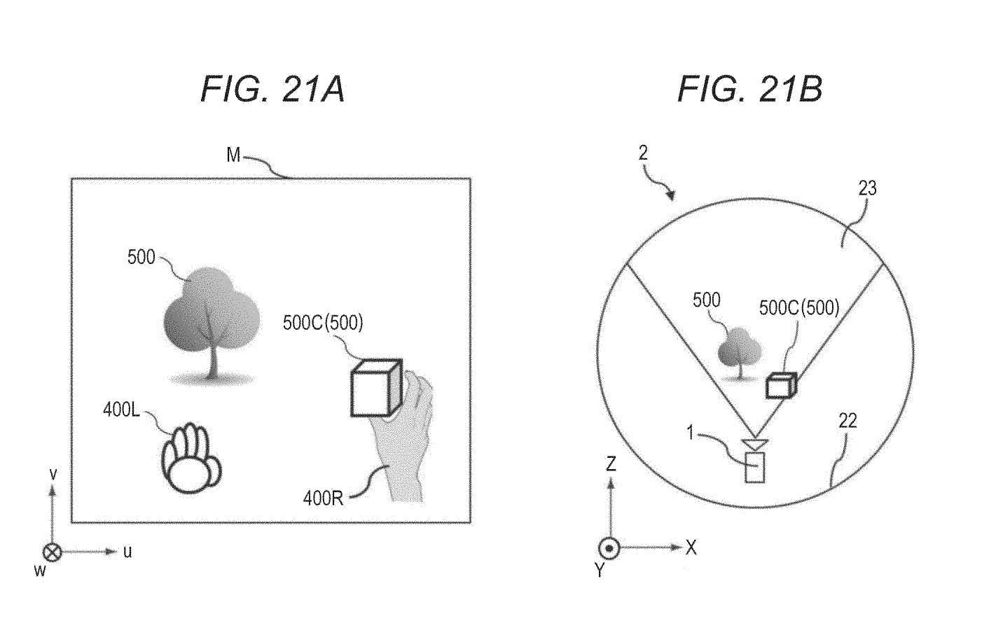

An action, according to least one embodiment, of the above-mentioned processing of Step S8 and Step S9 is described with reference to FIG. 18 to FIG. 21B. FIG. 18 and FIG. 19 are flowcharts of the processing of Step S8 and Step S9 of FIG. 11 of at least one embodiment. FIGS. 20A-B and FIGS. 21A-B are diagrams of a field of view image or a virtual space of at least one embodiment. FIG. 20A and FIG. 21A, are diagrams of the field-of-view image M of at least one embodiment, and FIG. 20B and FIG. 21B are diagrams of the virtual space 2 from the Y direction of at least one embodiment. In at least one embodiment, when an operation of indicating the target object 500 by the hand object 400 (hereinafter referred to as “indication operation”) is detected, the processor 10 determines and executes an action corresponding to the attribute of the target object 500 (first attribute information) and the attribute of the hand object 400 (third attribute information).

The processing of Step S8 of FIG. 11 performed in the second example is described in detail with reference to FIG. 18. In Step S181, the processor 10 moves the hand object 400 in the virtual space 2 in accordance with the movement of the hand of the user 190 detected by the controller 160.

In Step S182, the processor 10 determines whether or not the target object 500 is positioned ahead in a direction specified by the hand object 400. Examples of the direction specified by the hand object 400 include a direction toward which a palm of the hand object 400 is directed. Such a direction is detected based on, for example, output from the motion sensor 130 provided to the controller 160. In response to a determination that the target object 500 is thus positioned (YES in Step S182), the processor 10 detects the indication operation performed on the target object 500 by the hand object 400. Meanwhile, in response to a determination that the target object 500 is not thus positioned (NO in Step S182), the processor 10 continues to wait for the movement information on the hand of the user 190, and to control the movement of the hand object 400.

When the indication operation is detected in Step S183, Step S9 described above (see FIG. 11) is executed. The processing of Step S9 of at least one embodiment is described in detail with reference to FIG. 19.

In Step S191, the processor 10 acquires the first attribute information representing the attribute associated with the target object 500 set as the target of the indication operation. The processor 10 acquires the third attribute information representing the attribute associated with the hand object 400 being an operation subject of the indication operation. The processor 10 can refer to the object information 242 to acquire the first attribute information and the third attribute information. In this case, as an example, the first attribute information and the third attribute information are information representing a polarity (for example, an N-pole or an S-pole of a magnet) of the object.

In Step S192, the processor 10 refers to the first attribute information and the third attribute information acquired in Step S191 to determine whether or not the polarities of the target object 500 and the hand object 400 are different. That is, the processor 10 determines whether or not one of the target object 500 and the hand object 400 has a polarity of the S-pole with the other having a polarity of the N-pole.

In response to a determination that the polarities are different (YES in Step S192), in Step S193, the processor 10 determines the action of moving the target object 500 toward the virtual camera 1. That is, the processor 10 determines the action of moving toward the virtual camera 1 as the action to be executed, and determines the target object 500 as the execution subject of the action.

Meanwhile, in response to a determination that the polarities are the same (NO in Step S192), in Step S194, the processor 10 determines the action of moving the target object 500 away from the virtual camera 1. That is, the processor 10 determines the action of moving away from the virtual camera 1 as the action to be executed, and determines the target object 500 as the execution subject of the action.

In Step S195, the processor 10 causes the target object 500 determined as the execution subject of the action to execute the action determined in Step S193 or Step S194. The processor 10 serves as the virtual object control module 232 to execute Step S191 to Step S194 described above. When the action of moving the target object 500 toward the virtual camera 1 is determined in Step S193, the processor 10 serves as the virtual object control module 232 to execute Step S195 (moving the target object 500 toward the virtual camera 1). When the action of moving the target object 500 away from the virtual camera 1 is determined in Step S194, the processor 10 serves as the virtual object control module 232 to execute Step S195 (moving the target object 500 away from the virtual camera 1).

A third action is described with reference to FIGS. 20A-B and FIGS. 21A-B. FIGS. 20A-B are diagrams of a state immediately after the indication operation performed by the right hand object 400R on a target object 500C having a polarity different from that of the right hand object 400R is detected. In this case, when Step S193 and Step S195 described above and Step S10 and Step S11 of FIG. 11 are executed, the virtual space 2 in FIG. 21B is provided to the user 190. Specifically, the field-of-view image M obtained after moving the target object 500C toward the virtual camera 1 (FIG. 21A) is provided to the user 190 via the monitor 112 of the HMD device 110.

As described above, in at least one embodiment, the processor 10 determines and executes the action corresponding to properties of a magnet. That is, the processor 10 can determine an action based on a relationship between the attribute (polarity) of the target object 500 and the attribute of the hand object 400 (polarity). With this, variations of actions to be executed are increased, and the user 190 is provided with the virtual experience exhibiting a high entertainment value. As a result, the sense of immersion of the user 190 in the virtual space 2 can be improved.

In at least one embodiment, various changes can be made. For example, the determination of the second example may be combined with the determination of the first example described above. For example, the above description is described by taking a form of moving the target object 500, but the processor 10 may determine which one of the virtual camera 1 or the target object 500 is to be moved by executing the determination described with respect to FIGS. 12-17B above together. In this case, the processor 10 determines and executes the action to be executed and the execution subject of the action based on all of the attribute of the target object 500 (first attribute information), the attribute of the user 190 (second attribute information), and the attribute of the hand object 400 (third attribute information).

In at least one embodiment, the polarity of the left hand object 400L and the polarity of the right hand object 400R may be set so as to differ from each other. In this case, the user is provided with, for example, a game configured so that a plurality of target objects 500 to which polarities are assigned at random are to be collected by being attracted to the hand object 400 or other such game requiring both hands to be skillfully moved and therefore exhibiting a high entertainment value.

In at least one embodiment, the operation determined in advance may be an operation other than the above-mentioned indication operation. For example, the operation determined in advance may simply be an operation of bringing the hand object 400 within a predetermined distance from the target object 500.

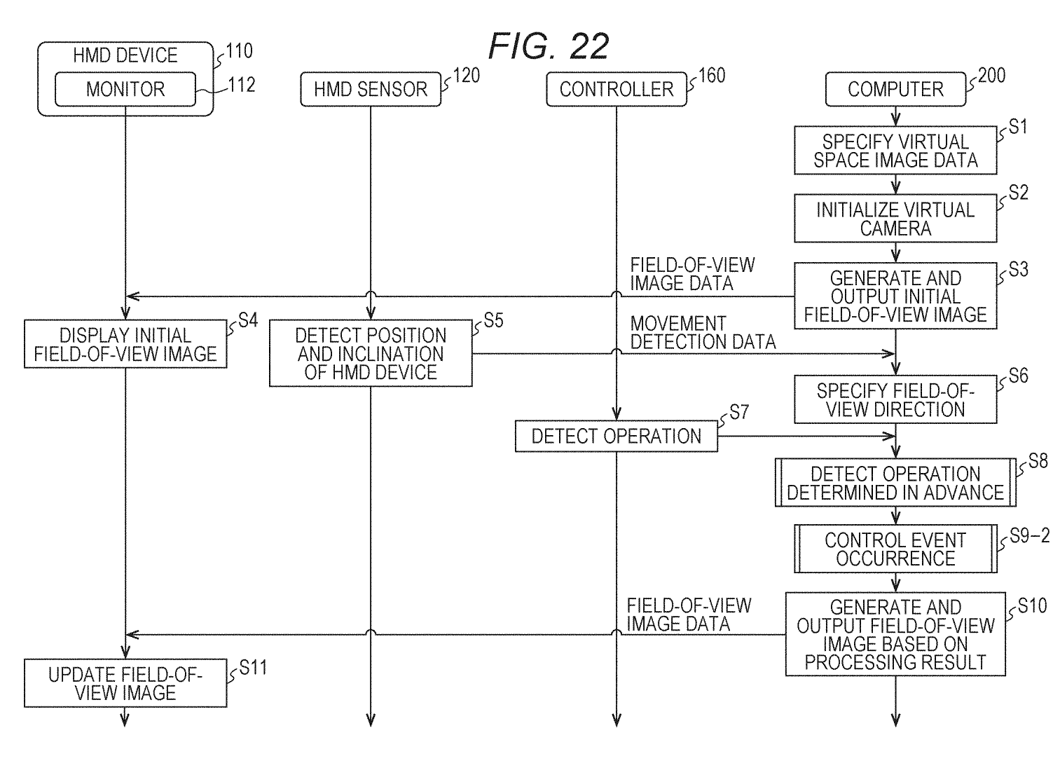

A control structure of the computer 200 of at least one embodiment is described with reference to FIG. 22. FIG. 22 is a flowchart of processing executed by the HMD system 100 of at least one embodiment. FIG. 22 has the same content as that of FIG. 9 except for Step S9-1. Therefore, an overlapping description is omitted.

When the grasping operation is detected in Step S84, Step S9-1 (see FIG. 22) is executed.

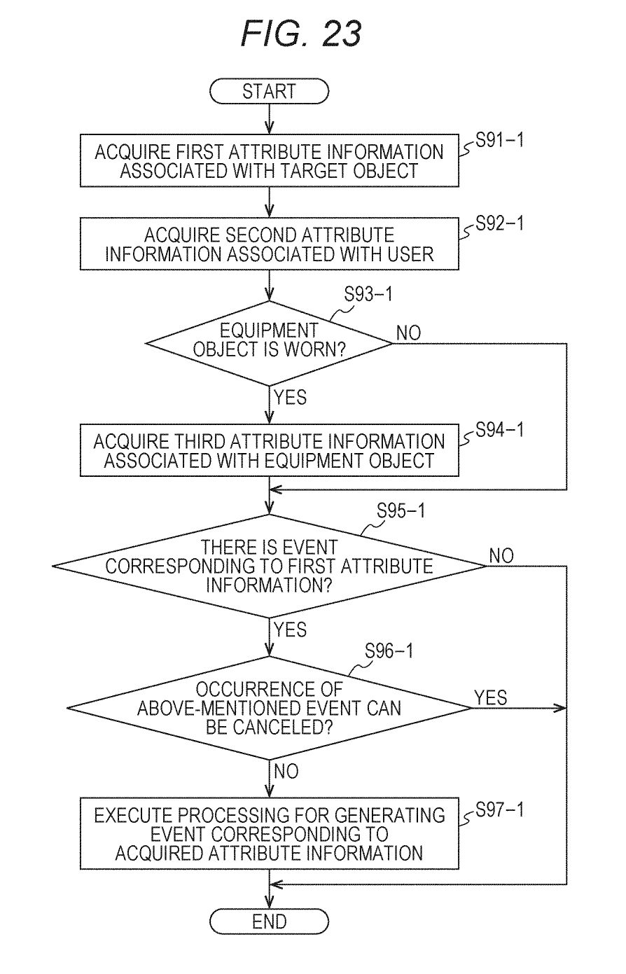

In Step S9-1, the processor 10 serves as the event control module 234 to control an event occurrence in the game situated in the virtual space 2 based on the attribute (first attribute information described above) associated with the target object 500 set as the target of the operation determined in advance (in this case, the grasping operation). Specifically, the processor 10 generates an event advantageous or disadvantageous to the user 190 based on the above-mentioned attribute. An example of the processing of Step S9-1 is described with reference to FIG. 23.

In Step S91-1, the processor 10 acquires the first attribute information representing the attribute associated with the target object 500 set as the target of the grasping operation. The processor 10 can refer to the object information 242 to acquire the first attribute information. For example, the first attribute information may include an attribute (for example, “high temperature” or “low temperature”) relating to a temperature of the target object 500, an attribute (for example, “state of being covered with thorns”) relating to a shape thereof, an attribute (for example, “slippery”) relating to a material thereof, and an attribute (for example, “heavy” or “light”) relating to the weight thereof. In addition to the above-mentioned attributes, the first attribute information may include an attribute relating to a characteristic (for example, “poisonous properties (for decreasing a stamina value)”, “recovery (for increasing a stamina value)”, or “properties that attract an enemy character”) set in advance in the game situated in the virtual space 2. For example, the temperature, weight, or other such attribute that can be expressed by a numerical value may be expressed by a numerical parameter (for example, “100° C.” or “80 kg”).

In Step S92-1, the processor 10 acquires the second attribute information representing the attribute associated with the user 190. In this case, the attribute associated with the user 190 may be an attribute associated with the character object (player character PC) being an avatar of the user 190 in the virtual space 2. The processor 10 can refer to the user information 243 to acquire the second attribute information. For example, the second attribute information may include a level, a skill (for example, resistance to various attributes), a hit point (stamina value representing an allowable amount of damage), an attacking power, and a defensive power of the player character PC in the game and other such various parameters used in the game.

In Step S93-1, the processor 10 determines whether or not an equipment object is worn on the player character PC or the hand object 400. When an equipment object is worn on the player character PC or the hand object 400, Step S94-1 is executed.

In Step S94-1, the processor 10 acquires the third attribute information representing an attribute associated with the equipment object. The processor 10 can refer to the object information 242 to acquire the third attribute information. For example, as the third attribute information, the weapon object is associated with an attacking power parameter for determining the amount of damage that can be exerted on an enemy with one attack, or other such parameter. As the third attribute information, the protector object is associated with a defensive power parameter for determining an amount of damage received due to an attack of the enemy, or other such parameter. In the same manner as the second attribute information described above, the third attribute information may include a parameter relating to the resistance to various attributes or other such equipment effect. Such an equipment object may be, for example, an item that can be acquired in the game (for example, an item that can be acquired from a treasure chest or the like being a kind of the target object), or may be a purchased item to be delivered to the user 190 in the game after payment therefor is made by the user 190 in the real world.

In Step S95-1, the processor 10 determines whether or not there is an event corresponding to the first attribute information and being advantageous or disadvantageous to the user 190 (that is, player character PC associated with the user 190). Examples of the event advantageous to the user 190 include an event for recovering the hit point of the player character PC and an event for drawing an item useful in the game or a friend (for example, an avatar of another user sharing the same virtual space 2 to play the same game) close to the player character PC. Examples of the event disadvantageous to the user 190 include an event for gradually decreasing the hit point of the player character PC, an event for setting a time period that allows the target object 500 to be continuously held (that is, an event for forcing the target object 500 to be released after the lapse of a set time period), and an event for drawing the enemy character close to the player character PC.

For example, the memory module 240 may hold table information for storing the first attribute information and the event corresponding to the first attribute information (when there is no corresponding event, information indicating that there is no corresponding event), which are associated with each other, as the object information 242. In the table information, for example, the first attribute information including “high temperature” and “state of being covered with thorns” may be associated with the event for gradually decreasing the hit point of the player character PC or other such event. For example, the first attribute information including “slippery” and “heavy” may be associated with the event for setting the time period that allows the target object 500 to be continuously held or other such event. By thus associating the target object 500 with the event that can easily be imagined from the attribute of the target object 500, an event with reality in the virtual space 2 is generated. The above-mentioned table information is, for example, downloaded onto the memory module 240 from the server 150 in advance as a part of the game program. In this case, the processor 10 can refer to the first attribute information on the target object 500 and the above-mentioned table information to determine the presence or absence of an event corresponding to the first attribute information.

When there is no event corresponding to the first attribute information in the above-mentioned table information (NO in Step S95-1), the processor 10 brings the processing of Step S9-1 to an end (see FIG. 22). Meanwhile, when there is an event corresponding to the first attribute information in the above-mentioned table information (YES in Step S95-1), the processor 10 executes the processing of Step S96-1.

In Step S96-1, the processor 10 determines whether or not the occurrence of the event (event corresponding to the first attribute information) specified in Step S95-1 can be canceled. Specifically, the processor 10 performs the above-mentioned determination based on at least one of the second attribute information or the third attribute information.

For example, consideration is given to a case in which the player character PC or the equipment object is associated with a heat-resistant skill (second attribute information) or a heat-resistant equipment effect (third attribute information) which can nullify an influence of the attribute “high temperature”. In this case, even when the first attribute information is “high temperature”, the processor 10 determines that the influence of the attribute can be nullified, and determines whether cancelling the occurrence of the “event for gradually decreasing the hit point of the player character PC” corresponding to the first attribute information is possible.

The second attribute information or the third attribute information may have an effect that can independently nullify the influence of one attribute as described above, or have an effect that cannot independently nullify the influence of one attribute (for example, an effect of reducing the influence of the attribute in half). In this case, the processor 10 may add up the effect of the second attribute information and the effect of the third attribute information to determine whether or not the occurrence of the event can be canceled based on a result of the addition. For example, when the player character PC is associated with a heat-reducing skill (second attribute information) that can decrease the influence of the attribute “high temperature” in half and the equipment object worn on the player character PC or the hand object 400 is associated with a heat-reducing equipment effect (third attribute information) that can decrease the influence the attribute “high temperature” in half, the processor 10 may add up the skill and the equipment effect to determine that the influence of the attribute “high temperature” can be nullified. In the same manner, when a plurality of equipment objects are worn on the player character PC or the hand object 400, the processor 10 may add up the equipment effects of the respective equipment objects (third attribute information) to determine whether or not the occurrence of the event can be canceled based on a result of the addition.

In response to a determination that the occurrence of the event can be canceled (YES in Step S96-1), the processor 10 brings the processing of Step S9-1 (see FIG. 22) to an end. Meanwhile, in response to a determination that the occurrence of the event cannot be canceled (NO in Step S96-1), the processor 10 executes the processing of Step S97-1.

In Step S97-1, the processor 10 executes processing for generating an event corresponding to the acquired attribute information. Specifically, the processor 10 generates an event (event advantageous or disadvantageous to the user 190) corresponding to the first attribute information. For example, the processor 10 can execute a program provided for each event, to thereby generate the event.

When the second attribute information or the third attribute information has an effect of increasing or decreasing (reducing) the influence of the first attribute information, the processor 10 may generate the event in consideration of the effect. For example, consideration is given to a case of generating the “event for gradually decreasing the hit point of the player character PC” corresponding to the attribute “high temperature” of the target object 500 (first attribute information). In this case, when the second attribute information or the third attribute information has the effect of decreasing the influence of the first attribute information, the processor 10 may decrease the influence of the above-mentioned event in consideration of the effect. For example, an influence (for example, the amount of damage received by the player character PC per unit time) set for the above-mentioned event by default may be decreased based on a magnitude (for example, a parameter indicating “to be reduced in half” or “to be reduced by 30%”) of the effect of the second attribute information or the third attribute information.

The processor 10 may output a sound (alert sound or the like) for notifying the user 190 of the occurrence of the event to a speaker (headphones) (not shown) or the like in the processing for generating the above-mentioned event. The processor 10 may operate a device (for example, the controller 160), which is worn on part (for example, a hand) of the user 190 and connected to the computer 200, based on details of the event. For example, when the player character PC receives a fixed amount of damage for each unit time, the processor 10 may vibrate the controller 160 each time the hit point of the player character PC is decreased. The magnitude and pattern of such vibrations may be determined based on the details of the event. For example, when the event advantageous to the user 190 (for example, the event for recovering the hit point of the player character PC) is generated, the processor 10 may cause the controller 160 to generate vibrations of a form (for example, relatively gentle and quick vibrations) that provides the user 190 with a sense of relief. Such processing enables the user 190 to intuitively understand an event that has occurred in the game based on the vibrations or the like transmitted to the body.

In Step S10, the processor 10 serves as the field-of-view region determining module 222 and the field-of-view image generating module 223 to generate the field-of-view image data for displaying the field-of-view image based on the result of the processing, and to output the generated field-of-view image data to the HMD device 110. In this case, the processor 10 may display a text message (for example, “Hit point recovered!” or “Hit point decreased due to a burn!”) indicating the details of the event that has occurred superimposed on the field-of-view image. In another case, when the parameter (for example, the hit point) of the player character PC is changed (recovered or decreased) due to the occurrence of the event, the processor 10 may display a numerical value indicator, a stamina gauge, or the like, which indicates the change of the parameter, superimposed on the field-of-view image. The processor 10 may visually change the state of at least one of the hand object 400 or the target object 500 in the field-of-view image depending on the event while displaying (or instead of displaying) the text message and the stamina gauge or the like (which is described later in detail).

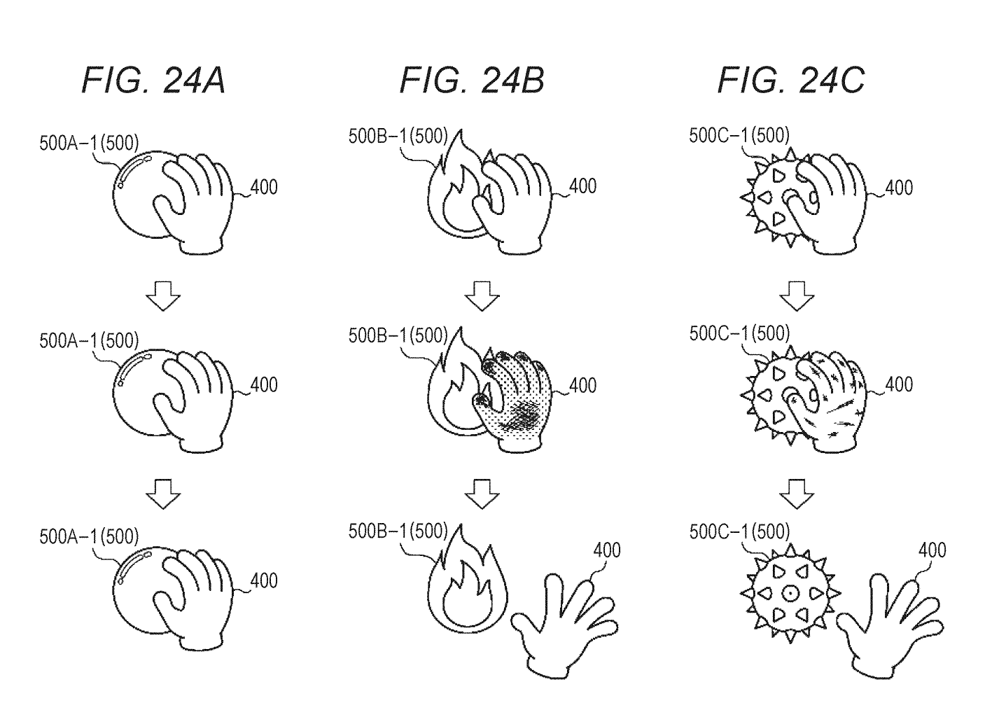

Processing for visually changing the state of the hand object 400 in the field-of-view image is described with reference to FIGS. 24A-C.

FIG. 24A is a diagram in which the grasping operation is executed by the hand object 400 on a target object 500A-1 being a ball having a size that can be grasped by the hand of at least one embodiment. In this example, the target object 500A-1 is not associated with the attribute (first attribute information) having the corresponding event. That is, neither an event advantageous to the user 190 nor an event disadvantageous to the user 190 is set for the target object 500A-1. In this case, in Step S95-1 a determination is made that there is no event corresponding to the first attribute information on the target object 500A-1, and no event advantageous or disadvantageous to the user 190 is generated. Therefore, during a period after the target object 500A-1 is grasped by the hand object 400 until an operation for releasing the target object 500A-1 is executed, the target object 500A-1 continues to be held by the hand object 400. In this manner, when no event advantageous or disadvantageous to the user 190 is generated, the state of the hand object 400 in the field-of-view image is not visually changed.

FIG. 24B is a diagram in which a target object 500B-1 being a fire ball is associated with the attribute “high temperature” (first attribute information) and the “event for gradually decreasing the hit point of the player character PC” corresponding to the attribute is generated. In this case, in Step S95-1, a determination is made that there is an event corresponding to the attribute “high temperature” of the target object 500B-1. In response to a determination in Step S96-1 that the occurrence of the event cannot be canceled (NO in Step S96-1), in Step S97-1, the processing for generating the event is executed. At this time, as in the middle of FIG. 24B, the processor 10 may display an image (or an effect) indicating that the influence of the attribute “high temperature” is exerted on the hand object 400 in the field-of-view image while the hand object 400 is holding the target object 500B-1 (that is, while the above-mentioned event is continued). In this example, a state in which the hand object 400 has redness and swelling due to a burn is expressed in the field-of-view image. The form of such an expression may be changed as the hit point of the player character PC decreases (or, for example, as a remaining time period during which the target object 500B-1 can be held decreases). For example, the processor 10 may gradually change the color of the hand object 400 in the field-of-view image so as to become darker red. In FIG. 23B, when the hand object 400 releases the target object 500B-1, the processor 10 may return the state of the hand object 400 to an original state (state before the burn). In the middle of FIG. 24B, the processor 10 may execute such a rendering as to display the text message “It's hot !!” or the like in the field-of-view image. In addition, the processor 10 may execute such a rendering as to cause the hand object 400 to temporarily execute an action not synchronized with the movement of the hand of the user 190. For example, the processor 10 may cause the hand object 400 to execute an action (for example, an action of waving the hand around) indicating that the hand feels hot regardless of the actual movement of the hand of the user 190. Subsequently, as in the bottom of FIG. 24B, the processor 10 may execute such a rendering as to release the target object 500B-1 from the hand object 400. After the rendering is finished, the processor 10 may return the hand object 400 to a position corresponding to the position of the hand of the user 190, and restart the action synchronized with the movement of the hand of the user 190.

FIG. 24C is a diagram in which a target object 500C-1 having a surface covered with thorns is associated with the attribute “state of being covered with thorns” (first attribute information) and the “event for gradually decreasing the hit point of the player character PC” corresponding to the attribute is generated of at least one embodiment. In this case, the above-mentioned event is generated as a result of executing the same determination processing as that in FIG. 24B. At this time, in the middle of FIG. 24C, the processor 10 may display an image (or an effect) indicating that the influence of the attribute “state of being covered with thorns” is exerted on the hand object 400 in the field-of-view image while the hand object 400 is holding the target object 500C-1 (that is, while the above-mentioned event is continued). In this example, a state in which the hand object 400 has a plurality of scratches caused by the thorns is expressed in the field-of-view image. The form of such an expression may be changed as the hit point of the player character PC decreases (or, for example, as the remaining time period during which the target object 500C-1 can be held decreases). For example, the processor 10 may gradually increase the number of scratches on the hand object 400 in the field-of-view image. In the bottom of FIG. 24C, when the hand object 400 releases the target object 500C-1, the processor 10 may return the state of the hand object 400 to an original state (state before the scratches are caused). Also in FIG. 24C, in the same manner as in FIG. 24B, the processor 10 may execute the renderings (displaying of the text message, action of the hand object 400, and the like) in the field-of-view image.

In FIGS. 24B-C, the state of the hand object 400 in the field-of-view image is visually changed depending on the event that has occurred, to thereby enable the user 190 to intuitively understand the event that has occurred in the game and the influence exerted by the event.

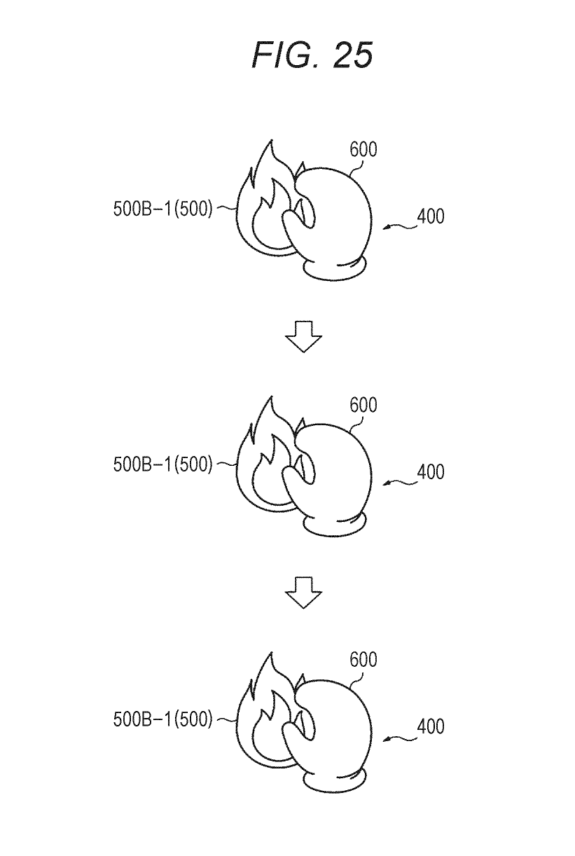

An example of processing performed when a glove 600 being an equipment object is worn on the hand object 400 is described with reference to FIG. 25. In this example, the glove 600 is associated with the equipment effect (third attribute information) that can nullify the influence of the attribute “high temperature”. In this case, in Step S95-1, a determination is made that there is an event corresponding to the attribute “high temperature” of the target object 500B-1. However, a determination is made in Step S96-1 that the occurrence of the event can be canceled, and hence the event is not generated. That is, the user 190 can nullify the influence of the attribute “high temperature” to continue to hold the target object 500B-1 by the hand object 400 wearing the glove 600 without decreasing the hit point of the player character PC. Therefore, the state of the hand object 400 is not visually changed in the field-of-view image.

The state of the target object 500 may be visually changed in the field-of-view image instead of (or while) visually changing the state of the hand object 400. For example, in FIG. 25, visual processing for extinguishing the fire of the target object 500B-1 held by the glove 600 may be performed. Such visual processing enables the user 190 to intuitively understand that the influence of the attribute “high temperature” has been nullified by the glove 600.

This concludes the description of some embodiments of this disclosure. However, the description of the above embodiments is not to be read as a restrictive interpretation of the technical scope of this disclosure. The above embodiments are merely given as an example, and are to be understood by a person skilled in the art that various modifications can be made to the above embodiments within the scope of this disclosure set forth in the appended claims. Thus, the technical scope of this disclosure is to be defined based on the scope of this disclosure set forth in the appended claims and an equivalent scope thereof.

For example, in some embodiments, the movement of the hand object is controlled based on the movement of the controller 160 representing the movement of the hand of the user 190, but the movement of the hand object in the virtual space may be controlled based on the movement amount of the hand of the user 190. For example, instead of using the controller 160, a glove-type device or a ring-type device to be worn on the hand or fingers of the user may be used. In this case, the HMD sensor 120 can detect the position and the movement amount of the hand of the user 190, and can detect the movement and the state of the hand and fingers of the user 190. The movement, the state, and the like of the hand and fingers of the user 190 may be detected by a camera configured to pick up an image of the hand (including fingers) of the user 190 in place of the HMD sensor 120. The picking up of the image of the hand of the user 190 through use of the camera permits omission of a device to be worn directly on the hand and fingers of the user 190. In this case, based on data of the image in which the hand of the user is displayed, the position, movement amount, and the like of the hand of the user 190 can be detected, and the movement, state, and the like of the hand and fingers of the user 190 can be detected.

In at least one embodiment, the hand object synchronized with the movement of the hand of the user 190 is used as the operation object, but this embodiment is not limited thereto. For example, a foot object synchronized with a movement of a foot of the user 190 may be used as the operation object in place of the hand object or together with the hand object.

In at least one embodiment, the execution subject of the action to be executed is determined to be one of the target object 500 and the virtual camera 1, but both the target object 500 and the virtual camera 1 may be determined as the execution subjects of the action. For example, in the above-mentioned second example, when the polarity of the target object 500 and the polarity of the hand object 400 are different, the processor 10 may determine an action of drawing the target object 500 and the virtual camera 1 (player character PC) to each other as the action to be executed. In this case, the processor 10 serves as the virtual camera control module 221 to move the virtual camera 1, and also serves as the virtual object control module 232 to move the target object 500.

In at least one embodiment, the visual field of the user defined by the virtual camera 1 is matched with the visual field of the player character PC in the virtual space 2 to provide the user 190 with a virtual experience to be enjoyed from a first-person point of view, but this at least one embodiment is not limited thereto. For example, the virtual camera 1 may be arranged behind the player character PC to provide the user 190 with a virtual experience to be enjoyed from a third-person point of view with the player character PC being included in the field-of-view image M. In this case, the player character PC may be moved instead of moving the virtual camera 1 or while moving the virtual camera 1. For example, in Step S95 of FIG. 13 described above, the processor 10 may move the player character PC toward the target object 500 in place of the virtual camera 1 or together with the movement of the virtual camera 1. For example, in Step S96 of FIG. 13 described above, the processor 10 may move the target object 500 toward the player character PC instead of moving the target object 500 toward the virtual camera 1. In this manner, when the user 190 is provided with the virtual experience to be enjoyed from the third-person point of view, the action of the virtual camera 1 (or the action of the target object 500 against the virtual camera 1) described in this at least one embodiment may be replaced by an action of the player character PC (or an action of the target object 500 against the player character PC). The action of the player character PC is executed by the processor 10 serving as the virtual object control module 232.

In at least one embodiment, the action of moving one of the virtual camera 1 and the target object 500 toward the other is described as an example of the action to be determined, but the action to be determined is not limited thereto. The attributes of the respective objects to be used for the determination are also not limited to the above-mentioned attributes. For example, the processor 10 may determine an action of deforming (or an action of avoid deforming) the target object 500 as the action to be executed based on the attribute of the target object 500 or the like. For example, consideration is given to a case in which the first attribute information associated with the target object 500 includes a numerical value indicating a hardness of the target object 500 and the second attribute information associated with the user 190 includes a numerical value indicating the power of the user 190 (grasping power). In this case, when detecting the grasping operation performed on the target object 500 by the hand object 400, the processor 10 may compare the hardness of the target object 500 and the power of the user 190 to determine whether or not the user 190 can destroy the target object 500. In response to a determination that the target object 500 can be destroyed, the processor 10 may determine an action of destroying the target object 500 as the action to be executed. Meanwhile, in response to a determination that the target object 500 cannot be destroyed, the processor 10 may determine an action of maintaining the target object 500 without destroying the target object 500 as the action to be executed.

[Supplementary Note 1]

### (Item 1)

An information processing method is executable by a computer 200 in order to provide a user 190 with a virtual experience in a virtual space 2. The information processing method includes generating virtual space data for defining the virtual space 2. The virtual space 2 includes a virtual camera 1 for defining a visual field of the user 190 in the virtual space 2; a target object 500 arranged in the virtual space 2; and an operation object (for example, a hand object 400) for operating the target object 500 (for example, S1 of FIG. 11). The method further includes detecting a movement of a part of a body of the user 190 to move the operation object in accordance with the detected movement of the part of the body (for example, S81 of FIG. 12 or S181 of FIG. 18). The method further includes detecting an operation determined in advance and performed on the target object 500 by the operation object (for example, S84 of FIG. 12 or S183 of FIG. 18). The method further includes acquiring, when the operation determined in advance is detected, first attribute information representing an attribute associated with the target object 500 to determine an action to be executed and determine at least one of the virtual camera 1 or the target object 500 as an execution subject of the action based on the first attribute information (for example, S91 to S96 of FIG. 13 or S191 to S194 of FIG. 19). The method further includes causing the at least one of the virtual camera 1 or the target object 500 determined as the execution subject to execute the action (for example, S97 of FIG. 13 or S195 of FIG. 19).

According to the method of this item, when an operation is performed on the target object by the operation object, the action to be executed and the execution subject of the action can be determined based on the attribute of the target object. With this, variations of the action to be executed when an operation is performed on the target object are increased. As a result, a user is provided with a virtual experience exhibiting a high entertainment value.

### (Item 2)

A method according to Item 1, in which the part of the body includes a hand of the user, and in which the operation determined in advance includes an operation of grasping the target object.

According to the method of this item, the variations of the action to be executed when such a basic operation as to grasp the target object in the virtual space is performed can be increased based on the attribute of the target object. With this, the entertainment value in the virtual experience of the user involving the use of the hand is improved.

### (Item 3)

A method according to Item 1 or 2, in which the action includes moving at least one of moving the virtual camera toward the target object or moving the target object toward the virtual camera.

According to the method of this item, when an operation is performed on the target object by the operation object, the target object is brought closer to the virtual camera, or the virtual camera is brought closer to the target object. With this, convenience of the user in the virtual space is improved.

### (Item 4)

A method according to Item 3, in which the first attribute information includes information indicating whether the target object is a movable object set so as to be movable in the virtual space or a stationary object set so as to be immovable in the virtual space.

According to the method of this item, which one of the target object or the virtual camera is to be moved is possible based on an attribute indicating whether or not the target object is movable in the virtual space.

### (Item 5)

A method according to any one of Items 1 to 4, in which the determining of the execution subject of the action includes further acquiring second attribute information representing an attribute associated with the user to determine the action to be executed and determine at least one of the virtual camera or the target object as the execution subject of the action further based on the second attribute information.

According to the method of this item, when an operation is performed on the target object by the operation object, a determination is made with respect to an action corresponding to a relationship between the attribute of the target object and the attribute of the user. With this, variations of the action to be executed are increased, and the user is provided with the virtual experience exhibiting a high entertainment value.

### (Item 6)

A method according to any one of Items 1 to 5, in which the determining of the execution subject of the action includes further acquiring third attribute information representing an attribute associated with the operation object to determine the action to be executed and determine at least one of the virtual camera or the target object as the execution subject of the action further based on the third attribute information.

According to the method of this item, when an operation is performed on the target object by the operation object, variations of the action to be executed can be increased based on a relationship between the attribute of the target object and the attribute of the operation object. With this, the user is provided with the virtual experience exhibiting a high entertainment value.

### (Item 7)

An information processing method is executable by a computer in order to provide a user with a virtual experience in a virtual space. The information processing method includes generating virtual space data for defining the virtual space. The virtual space includes a virtual camera configured to define a visual field of the user in the virtual space; a character object arranged in the virtual space so as to be included in the visual field of the user; a target object arranged in the virtual space; and an operation object for operating the target object. The method further includes detecting a movement of a part of a body of the user to move the operation object in accordance with the detected movement of the part of the body. The method further includes detecting an operation determined in advance and performed on the target object by the operation object. The method further includes acquiring, when the operation determined in advance is detected, first attribute information associated with the target object to determine an action to be executed and determine at least one of the character object or the target object as an execution subject of the action based on the first attribute information. The method further includes causing the at least one of the character object or the target object determined as the execution subject to execute the action.

According to the method of this item, a similar effect as that of Item 1 can be obtained in a virtual experience provided from a third-person point of view.

### (Item 8)

A system for executing the method of any one of Items 1 to 7.

### (Item 9)

An apparatus, including:

a memory having instructions for executing the method of any one of Items 1 to 7 stored thereon; and

a processor coupled to the memory and configured to execute the instructions.

[Supplementary Note 2]

### (Item 10)

An information processing method is executable by a computer 200 in order to allow a user 190 to play a game in a virtual space 2 via a head-mounted display (HMD device 110). The information processing method includes generating virtual space data for defining the virtual space 2. The virtual space includes a virtual camera 1 configured to define a field-of-view image to be provided to the head-mounted display; a target object 500 arranged in the virtual space 2; and an operation object (for example, a hand object 400) for operating the target object 500 (for example, S1 of FIG. 22). The method further includes detecting a movement of a part of a body of the user 190 to move the operation object in accordance with the detected movement of the part of the body (for example, S81 of FIG. 12). The method further includes detecting an operation determined in advance and performed on the target object 500 by the operation object (for example, S84 of FIG. 12). The method further includes acquiring, when the operation determined in advance is detected, first attribute information representing an attribute associated with the target object 500 to control of an occurrence of an event advantageous or disadvantageous to the user 190 in the game based on the first attribute information (for example, S9-1 of FIG. 22).

According to the information processing method of this item, the event advantageous or disadvantageous to the user in the game can be generated based on the attribute of the target object. For example, in the virtual space, generating an event similar to an event in the real world that the user receives damage when grasping a hot object, an object that causes a pain when touched, or other such object is possible. With this, the reality of the virtual space is enhanced, and the sense of immersion of the user in the game is improved.

### (Item 11)

An information processing method according to Item 10, in which the controlling of the occurrence of the event includes further acquiring second attribute information representing an attribute associated with the user to control the occurrence of the event based on the second attribute information.

According to the information processing method of this item, the progress (presence or absence of an event occurrence, form of the event occurrence, or the like) of the game can be changed depending on the attribute (for example, a resistance value to the first attribute information) associated with the user (including an avatar associated with the user in the virtual space). With this, the entertainment value of the game provided in the virtual space is improved.

### (Item 12)

An information processing method according to Item 10 or 11, in which the step of controlling the occurrence of the event includes further acquiring third attribute information representing an attribute associated with an equipment object worn on at least one of the operation object or a character object associated with the user to control the occurrence of the event further based on the third attribute information.

According to the information processing method of this item, the progress of the game can be changed depending on the attribute associated with the equipment object. With this, the entertainment value of the game provided in the virtual space is improved.

### (Item 13)

An information processing method according to any one of Items 10 to 12, further including a step of visually changing a state of at least one of the operation object or the target object in the field-of-view image depending on the event.

According to the information processing method of this item, the user 190 is able to intuitively understand the event that has occurred in the game.

### (Item 14)

An information processing method according to any one of Items 10 to 13, further including a step of operating a device, which is worn on a part of the body of the user and connected to the computer, based on the event.

According to the information processing method of this item, the user 190 is able to intuitively understand the event that has occurred in the game.

### (Item 15)

An information processing method according to any one of Items 10 to 14, in which the first attribute information includes information relating to at least one of a temperature, a shape, a material, or a weight of the target object.

According to the information processing method of this item, an event similar to an event in the real world can be generated based on an attribute of a general object. As a result, the sense of immersion of the user in the game situated in the virtual space is improved.

### (Item 16)

An information processing method according to any one of Items 10 to 15, in which the first attribute information includes information relating to a characteristic set in the game in advance.

According to the information processing method of this item, events corresponding to various characteristics set in the game can be generated. As a result, the sense of immersion of the user in the game situated in the virtual space is improved.

### (Item 17)

A system for executing the information processing method of any one of Items 10 to 16 on a computer.

### (Item 18)

An apparatus, including:

a memory having instructions for executing any one of Items 10 to 16 stored thereon; and

a processor coupled to the memory and configured to execute the instructions.

1-12. (canceled)

13. A method, comprising:
defining a virtual space, wherein the virtual space comprises:
a virtual camera, wherein the virtual camera is configured to define a visual field in the virtual space;
a target object; and
an operation object for operating the target object;
detecting a movement of a part of a body of a user wearing a head-mounted device (HMD);
moving the operation object in accordance with the detected movement of the part of the body;
specifying an operation determined in advance and performed on the target object by the operation object;
detecting that the operation determined in advance has been executed based on the detected movement of the part of the body;
setting one of the virtual camera or the target object as an execution subject based on first attribute information, wherein the first attribute information represents an attribute associated with the target object; and
causing the execution subject to execute an action corresponding to a movement of the operation object.

14. The according to claim 13,
wherein detecting of the movement of the part of the body includes detecting movement of a hand of the user,
wherein the operation determined in advance includes an operation for selecting the target object, and
wherein the action corresponding to the movement of the operation object is to bring the target object selected by the operation object closer to the virtual camera.

15. The according to claim 13, further comprising setting the virtual camera as the execution subject,
wherein the causing of the one of the virtual camera or the target object to execute the action corresponding to the movement of the operation object includes moving the virtual camera toward the target object.

16. The method according to claim 13, further comprising setting the target object as the execution subject,
wherein the causing of the one of the virtual camera or the target object to execute the action corresponding to the movement of the operation object includes moving the target object toward the virtual camera.

17. The method according to claim 13,
wherein the first attribute information includes information indicating whether the target object is a movable object or a stationary object,
wherein the movable object is set so as to be movable in the virtual space in accordance with the movement of the operation object,
wherein the stationary object is set so as to be immovable in the virtual space in accordance with the movement of the operation object, and
wherein the method further comprises:
determining the target object as the execution subject in response to the first attribute information indicating that the target object is the movable object; and
determining the virtual camera as the execution subject in response to the first attribute information indicating that the target object is the stationary object.

18. The method according to claim 13, wherein the setting of one of the virtual camera or the target object as the execution subject is based on the first attribute information and second attribute information, and the second attribute information represents an attribute associated with the user.

19. The method according to claim 18,
wherein the first attribute information includes a parameter representing a weight of the target object,
wherein the second attribute information includes a parameter representing a weight of the user or a character object associated with the user, and
wherein the method further comprises determining the virtual camera as the execution subject in response to the weight of the target object being greater than the weight of the user or the character object associated with the user.

20. The method according to claim 18,
wherein the first attribute information includes a parameter representing a weight of the target object,
wherein the second attribute information includes a parameter representing a power of the user or a character object associated with the user, and
wherein the method further comprises determining the target object as the execution subject in response to the power of the user or the character object associated with the user having a value larger than a threshold value determined based on the weight of the target object.

21. The method according to claim 13, wherein the setting of one of the virtual camera or the target object as the execution subject is based on the first attribute information and third attribute information, and the third attribute information is associated with the operation object.

22. The method according to claim 21, further comprising
determining whether the first attribute information and the third attribute information have parameters of a same kind,
wherein the setting of one of the virtual camera or the target object as the execution subject is based on whether the first attribute information and the third attribute information have parameters of the same kind.

23. A system comprising:
a head-mounted display; and
a processor in communication with the head-mounted display, wherein the processor is configured for:
defining a virtual space, wherein the virtual space comprises:
a virtual camera, wherein the virtual camera is configured to define a visual field in the virtual space;
a target object; and
an operation object for operating the target object;
detecting a movement of a part of a body of a user wearing the head-mounted display;
moving the operation object in accordance with the detected movement of the part of the body;
specifying an operation determined in advance and performed on the target object by the operation object;
detecting that the operation determined in advance has been executed based on the detected movement of the part of the body;
setting one of the virtual camera or the target object as an execution subject based on first attribute information, wherein the first attribute information represents an attribute associated with the target object; and
causing the execution subject to execute an action corresponding to a movement of the operation object.

24. An apparatus comprising:
a memory configured to store instructions thereon; and
a processor in communication with the memory, wherein the processor is configured to execute the instructions for:
defining a virtual space, wherein the virtual space comprises:
a virtual camera, wherein the virtual camera is configured to define a visual field in the virtual space;
a target object; and
an operation object for operating the target object;
detecting a movement of a part of a body of a user wearing a head-mounted device (HMD);
moving the operation object in accordance with the detected movement of the part of the body;
specifying an operation determined in advance and performed on the target object by the operation object;
detecting that the operation determined in advance has been executed based on the detected movement of the part of the body;
setting one of the virtual camera or the target object as an execution subject based on first attribute information, wherein the first attribute information represents an attribute associated with the target object; and
causing the execution subject to execute an action corresponding to a movement of the operation object.
